(19) United States
(12) Patent Application Publication
(10) Pub. No.: US 2008/0027763 A1
(43) Pub. Date: Jan. 31, 2008

(54) COMPUTER SYSTEM

(76) Inventors: Crispina O. Caballero, Stouffville (CA); Thomas F. Conroy, Englewood, CO (US); Peter H. Gilman, Cedar Rapids, IA (US)

Correspondence Address: PETER K. TRZYNA, ESQ., P O BOX 7131, CHICAGO, IL, 60680, US

(21) Appl. No.: 11/828,954

(22) Filed: Jul. 26, 2007

Related U.S. Application Data
(63) Continuation-in-part of application No. 60/833,334, filed on Jul. 26, 2006.

(51) Int. Cl. G06Q 40/00

(52) U.S. Cl. 705/4

(57) ABSTRACT

Computer machine, manufacture, methods of making and using the same, and product produced thereby, as well as necessary intermediates, each pertaining to a system of the kind adapted to transform insurance risk for a transaction, in cooperation with different entities with respective computing systems. Embodiments transforming insurance risks into credit risks to accomplish one or more financial guarantees are preferably carried out in multiple jurisdictions.

### I. PRIORITY STATEMENT

This patent application is a continuation-in-part, claiming priority from, and incorporating by reference, U.S. Ser. No. 60/833,334, filed 26 Jul. 2006 by the same inventors, and titled “COMPUTER SYSTEM FOR MANAGING PERFORMANCE GUARANTEE.”

### II. BACKGROUND

A. Technical Field

A computer machine/system, manufacture, methods of making and using the same, and product produced thereby, as well as necessary intermediates, each pertaining to a system of the kind useful in and suitable for managing performance guarantees.

B. Background

In certain jurisdictions, including the North Sea, oil and gas companies are required to post security to insure decommissioning of currently operating rigs. Various forms of security are acceptable including Letters of Credit, Insurance Policies and financial assets.

Further in certain countries, including the U.K, there are Pension Protection Funds established as statutory funds governed by a Regulatory Authority under governmental laws or regulations and established to pay compensation to members of eligible defined benefit pension schemes when there is a qualifying insolvency event in relation to the employer and where there are insufficient assets in the pension scheme to cover Pension Protection Fund levels of compensation. Such Regulatory Authorities also calculate a risk-based levy imposed on member schemes and may require security to be posted for the difference between the assets required to meet the defined benefit commitments of an employer and the actual assets in the employer's plan. Contingent assets (security) acceptable to such Regulatory Authorities have usually been in the form of Letters of Credit and bank guarantees.

Letters of Credit are widely used, but they are one (1) year renewable and prices could change. Longer term solutions and pricing are desired in the market.

Computer system structure, to the extent known, would seem to be directed to these techniques of posting security.

### III. BRIEF DESCRIPTION OF THE DRAWINGS

FIG. 1 is a graphic representation of a transaction for transforming an insurance risk into a credit risk to accomplish one or more financial guarantees.

FIG. 2 is a flowchart showing the logic of the logic means for controlling the computer system in accordance with an embodiment.

FIG. 3 is a flowchart showing the data input, computational and other logic, and the data output of the logic means for controlling the computer system in accordance with an embodiment.

FIGS. 4-6 represent a flowchart showing an embodiment.

FIG. 4, which continues through FIG. 6, represents a portion of a flowchart showing an embodiment.

FIG. 5 is a continuation of FIG. 4, and represents a portion of a flowchart showing an embodiment.

FIG. 6 is a continuation of FIG. 4, and represents a portion of a flowchart showing an embodiment.

FIGS. 7-12 represent a flowchart showing an embodiment.

FIG. 7, which continues through FIG. 12, represents a portion of a flowchart showing an embodiment.

FIG. 8 is a continuation of FIG. 7, and represents a portion of a flowchart showing an embodiment.

FIG. 9 is a continuation of FIG. 7, and represents a portion of a flowchart showing an embodiment.

FIG. 10 is a continuation of FIG. 7, and represents a portion of a flowchart showing an embodiment.

FIG. 11 is a continuation of FIG. 7, and represents a portion of a flowchart showing an embodiment.

FIG. 12 is a continuation of FIG. 7, and represents a portion of a flowchart showing an embodiment.

FIGS. 13-18 represent a flowchart showing an embodiment.

FIG. 13, which continues through FIG. 18, represents a portion of a flowchart showing an embodiment.

FIG. 14 is a continuation of FIG. 13 and represents a portion of a flowchart showing an embodiment.

FIG. 15 is a continuation of FIG. 13 and represents a portion of a flowchart showing an embodiment.

FIG. 16 is a continuation of FIG. 13 and represents a portion of a flowchart showing an embodiment.

FIG. 17 is a continuation of FIG. 13 and represents a portion of a flowchart showing an embodiment.

FIG. 18 is a continuation of FIG. 13 and represents a portion of a flowchart showing an embodiment.

FIGS. 19-22 represent a flowchart showing an embodiment.

FIG. 19, which continues through FIG. 22, represents a portion of a flowchart showing an embodiment.

FIG. 20 is a continuation of FIG. 19 and represents a portion of a flowchart showing an embodiment.

FIG. 21 is a continuation of FIG. 19 and represents a portion of a flowchart showing an embodiment.

FIG. 22 is a continuation of FIG. 19 and represents a portion of a flowchart showing an embodiment.

FIG. 23 is a graphic representation of interrelated computer systems in accordance with an embodiment.

FIG. 24 is a graphic representation of interrelated computer systems in accordance with an embodiment.

FIG. 25 is a graphic representation of interrelated computer systems in accordance with an embodiment.

FIG. 26 shows a partial representation of the computer system in the network system in accordance with an embodiment.

### IV. MODES

With regard to a technical problem being solved by a technical solution, consider first the setting: Accomplishing certain performance or financial guarantees discussed herein would involve distinct entities in distinct jurisdictions. It would be difficult at best for different entities in different jurisdictions to coordinate and cooperate to accomplish the ends discussed subsequently in greater detail. Further, it is believed that it is not common to think in terms of structuring a computer system so as to be selectively multijurisdictional to involve distinct entities.

Providing a computing system architecture structured to enable the coordination and cooperation to the particular ends discussed in greater detail herein, is provided hereby. Additionally, by adding a centralizing computing structure overlay to the multijurisdictional computer system, advantageous aspects unique to the jurisdictions can be selectively utilized, while biases and disadvantages can be addressed, in a centrally balanced manner. Further, because each of the entities can be expected to have its own agenda and objectives that are complicated by the diverse jurisdictions, a central computer system overlay is provided to help to deal with converting between different entities and issues of the various jurisdictions through actions of an unbiased (central or facilitating) party.

Contrast PCT application US2004/014082 in noting that the present embodiments involve computer support systems structured and adapted to control implementation of certain performance or financial guarantees that can be embodied in a financial product or instrument. For example, when a third party (the insured or party guaranteed) is obligated to perform a certain task or tasks or meet certain requirements for a first party (the beneficiary), a second party (the insurance carrier), will guarantee fulfillment of the specified tasks if the third party fails to perform. Embodiments allow the second party to efficiently and effectively transfer its risk to a capital markets, and can utilize a computer system controlled to transform insurance risk for a transaction, in partnership with different corporate entities in different jurisdictions.

A Guarantee of Fulfillment may take the form of a bond that will provide for the provision of funds to complete the tasks up to a specified amount limit and for a fixed term of guarantee. Accomplishing these financial guarantees can involve implementing the financial product in different jurisdictions, preferably utilizing the capital markets more effectively, and taking advantage of different risk tolerances to transform insurance risk into credit risk in partnership with different corporate entities, to accomplish one or more financial guarantees. Hence computer systems can, depending on the embodiment, span jurisdictions—i.e., a multijurisdictional computer system adapted with central control so as to support the unique financial product or bond.

Such financial products could be bonds which guarantee the presence of funds to de-commission an off-shore oil platform and wells and a bond which covers the difference between a defined benefit pension plan's forecasted obligations and the value of the assets in the pension plan. The computer system herein can be used in other applications, but these examples are particularly instructive for understanding the nature of the computing systems and challenges to uniting them into cooperation spanning multiple entities in multiple jurisdictions.

For example, the insurance carrier can issue the bond after receiving an indemnity (from the party guaranteed or an affiliate) on which a credit swap can be purchased in a capital market. The agreement can provide that any payment under the bond will be promptly repaid by the indemnifier. The insurance carrier may or may not purchase a credit swap on the indemnifier.

Should the insurance carrier have a payment under the bond, the carrier will be promptly reimbursed by the indemnifier. Otherwise, a judgment can be obtained against the indemnifier and either be paid or create a “credit event” (usually a bankruptcy). If there has been a purchase of a credit swap, the loss will be transferred to the counterparty in the capital market for the amount of the swap. If the swap amount equals the bond amount, the insurance carrier will be fully covered.

A unique system of interrelated computers structured and adapted (preferably) to cooperate, as well as a computer system management overlay, find utility and industrial applicability in carrying out the foregoing.

One aspect of the foregoing is management of the amount of the swap versus the amount of the bond and the length of the swap versus the length of the bond. The swap length should go far enough past the bond end date to cover the time to trigger the “credit event”.

The structure, and corresponding computing, can be varied so that the issuing insurance carrier reinsures the contract to another insurance carrier who gets the indemnity and buys the swap. The reinsurer could be a “transformer” reinsurer which is a Special Purpose Vehicle (SPV) built to transform insurance risk to capital markets risk. It is also possible that the issuing insurance carrier is a “transformer” SPV which places the risk into the Capital Markets. It is also possible that the transformer could be a captive or affiliate of the party whose performance is being guaranteed.

For example, this approach can be used to make available longer term solutions with capital market pricing to the oil and gas decommissioning security market. In certain jurisdictions, including the North Sea, oil and gas companies are required to post security to insure decommissioning of currently operating rigs. The removal of all platforms, rigs and other well equipment by the oil company at the time the well(s) is taken out of production is referred to as “De-Commissioning”. In the North Sea Oil field, to ensure that the oil company will perform, the company can be required to post acceptable collateral with the De-Commissioning Authority. Cost Estimate procedures and formulas are specified by the Authority. Acceptable collateral includes Assets in Trust, Bank Letters of Credit, and Performance Bonds for the Estimated Cost. Trusts, banks and bond carriers are usually required to be domiciled in an OECD country with a branch in the United Kingdom and with at least an AA rating from Standard and Poor's, or AA2 rating from Moody's or an equivalent rating by another recognized rating agency. Letters of Credit are widely used, but they are 1 year renewable and prices could change.

Another approach can involve, for example, an insurance carrier, which, in a specific jurisdiction x, writes an insurance policy, which should carry at least a Standard and Poor's AA rating or equivalent rating from a recognized rating agency, to an oil company, an insured. The policy will be provided to the Decommissioning Authority of another jurisdiction y as security for the decommissioning and must be acceptable by them. The policy can be a fixed term Performance Indemnity Bond to be issued by the insurance carrier.

The insurance carrier could enter a Credit Swap agreement with an investor, which should carry at least a Standard and Poor's AA rating or its equivalent in jurisdiction y. Investor would accept the default risk under the Performance Indemnity Bond for the duration of the term of cover. Investor could enter a “put” contract with the parent of the insured where it could put its position in the swap with the insurance carrier to the parent. Investor could also buy Credit Default swaps in the market on the parent should they so desire. This would depend on their view of the risk and the swap market. The insurance carrier could accept the investor credit risk or buy protection against the investor in the Credit market.

The policy could be issued out of a segregated account of a licensed insurer which has Segregated Account authority. The investor credit swap as well as the other contracts could be included in the segregated account, so the policy owner would have all of the protection of all the contracts. If needed, the segregated account could be “credit enhanced” with a monoline wrap. The investor would be the equity owner and investment manager of the segregated account, which most likely would be a segregated account of the insurance carrier.

This idea can be carried out with other financial guarantees, with other particular jurisdictions, and with other financial products in making use of the general idea of managing performance guarantee utilizing the capital market more effectively, and taking advantage of different risk tolerances of different corporate entities, to accomplish one or more financial guarantees. Financial guarantees can be provided but could not be accomplished as efficiently as this approach of implementing a performance indemnity bond by a full transfer of the risks to the Capital Markets, particularly the Credit Default Swap market.

More particularly as a representative example, consider an Insurance Bond for a Fixed Amount and for a Fixed Term. Segregated Account A (of Insurance Carrier) in jurisdiction x, owned and guaranteed by a rated Corporation issues a Performance Indemnity Bond to the Decommissioning Authority in jurisdiction y in favor of XYZ Oil Company, a subsidiary of ABC Holdings. XYZ pays the premium. The Bond provides that, should XYZ not perform the decommissioning in jurisdiction y as specified, that Segregated Account A will pay £XXX million toward the decommissioning. The Bond is valid for 5 years, and may or may not be renewed at Segregated Account A's option.

Segregated Account A 100% co-insures the policy to Segregated Account B (of another insurance carrier) in jurisdiction x, a subsidiary of investor. Segregated Account B transfers all risk to investor in jurisdiction y. Investor is domiciled in an OECD country with a branch in jurisdiction y and with an acceptable rating in jurisdiction y. Investor enters into a contract with ABC where ABC guaranties the performance of XYZ in the decommissioning for the full term of the Bond. Investor's risk is that neither XYZ nor ABC can perform. Investor manages this risk by hedging it in the Credit Default Swap market. Investor can, for example, be required to place the contract with ABC and may be required (depending on the embodiment) to place the market hedges, in Segregated Account B.

In other embodiments, first, issuing Insurance Carrier could be a “transformer” SPV which could place the risks into the Capital Markets; second, issuing Insurance Carrier could reinsure the contract to a “transformer” reinsurer which is a SPV built to transform an insurance risk to capital market risk; or third, the transformer could be a captive or affiliate of the party whose performance is being guaranteed.

Embodiments herein can be viewed as comprising computer support (including documentation, tracking, valuation, regulatory compliance, accounting, etc.) involving contracts (insurance, reinsurance, credit support, guarantees, swaps, wraps, agreements, considerations, claims, fees and other provisions) possibly, in different jurisdictions. This multi-contractual and multi-jurisdictional structure is coordinated to accomplish transforming insurance risks to credit risks to provide financial guarantees that could not be accomplished as efficiently without this approach.

Computer support, for example, can handle inputting data, analyzing the data, evaluating the risks, to determine the best approach to the implementation of the insurance policy and/or the financial product and/or rights and/or benefits or responsibilities associated therewith, etc., generating documentation, producing illustrations and reports, contracts, accounting and accounting results, particularly for the different entities and in correspondence to the jurisdictions, consolidated data, etc. Preferably there are multi-jurisdictional computer systems for access, and the human-facilitating of the entire computer-assisted system can span even more jurisdictions. In view of the complexity of the transactions associated with this innovation, it may be best to establish standardization, especially with data standards. Thus, such an embodiment contemplates data standards carried out from data templates and generally standardized documentation (with customization as is needed for individual transactions).

Indeed, computer support, as well as a system for controlling the computer support, which could be a menu a logic overlay or control means for the computer system, collectively forming the backbone for a multi-contractual and multi-jurisdictional approach, with support reaching to many related activities, including optimizing product fulfillment, risk evaluating, optimizing pay outs, communications with all involved parties (including providers, intermediaries, etc.), reporting, billing and transfers (including electronic funds transfers), protected communications by encryption, records management, real time and batch processing utilizing distributed networks and Internet communications, product partitioning and determinations related thereto, as well as packaging benefits and parts thereof, budgeting, claims processing, reporting, and coding to track aspects of this multi-contractual and multi-jurisdictional approach, partitioning optimization and analysis, and even business to business referrals for associated products and services.

In accordance with the foregoing, there can be one or more apparatus (computer system(s)), methods of making and using the apparatus, and products (documentation and other output) as well as necessary intermediates (e.g., data, documents, etc.).

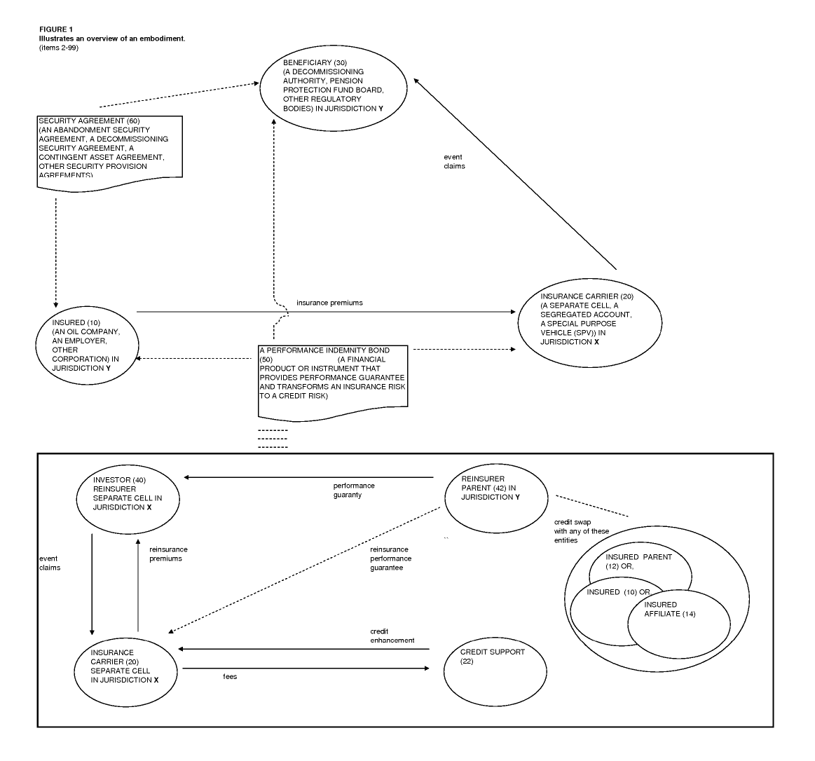

In an embodiment (see FIG. 1), Insurance Carrier 20 issues a Performance Indemnity Bond 50 to Insured 10 for the benefit of Beneficiary 30. The Bond 50 meets the Acceptable Security requirements or specifications of Beneficiary 30 and such requirements, illustratively including any calculations and processes are as discussed in Security Agreement 60. Insured 10 pays insurance premiums to Insurance Carrier 20 in exchange for event claims payments to Beneficiary 30.

Performance Indemnity Bond 50 incorporates issuance of policy by a Separate Cell 20 which is credit enhanced by a rated Credit Support 22, if need be; reinsurance of event risks in exchange for reinsurance premiums with a Reinsurer Separate Cell 40, which in turn is credit enhanced by Reinsurer Parent 42, and such Reinsurer Parent 42 also providing reinsurance performance guarantee to Insurance Carrier Separate Cell 20; and if needed, a credit swap between Reinsurer Parent 42 and any one of Insured 10, Insured Parent 12, and Insured Affiliate 14. Thereby transforming insurance risk in jurisdiction x to a financial risk in jurisdiction y.

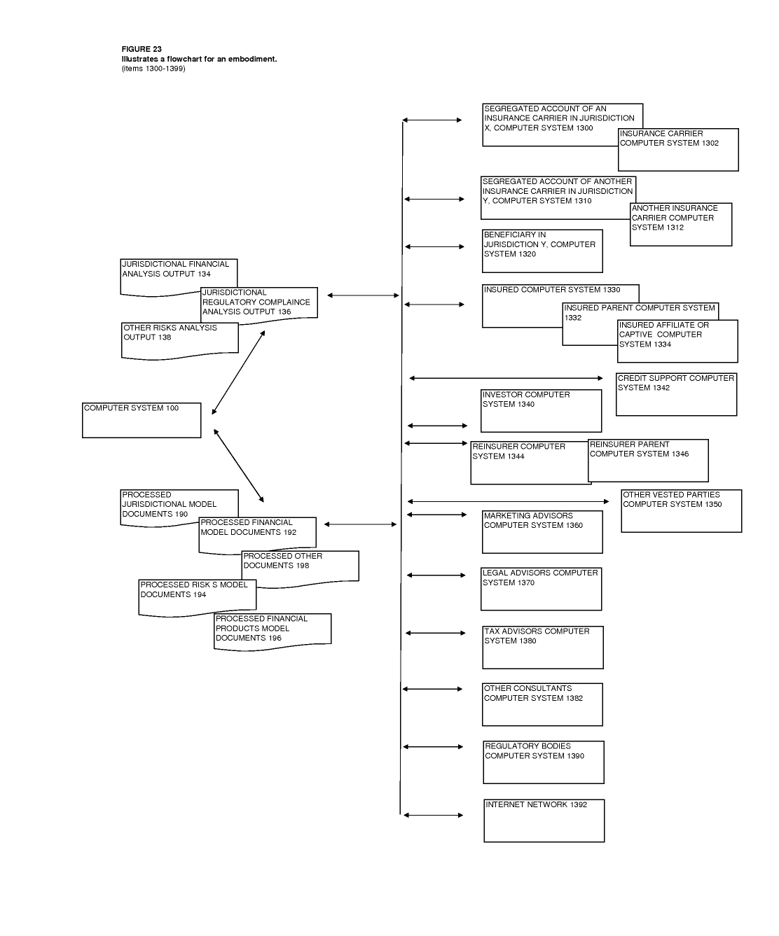

Such an embodiment involves a network of computer systems possibly in multiple jurisdictions (see FIG. 23) where output, Jurisdictional Financial Analysis Output 134, Jurisdictional Regulatory Compliance Analysis Output 136, Other Risks Analysis Output 138, and models documents, Processed Jurisdictional Model Documents 190, Processed Financial Model Documents 192, Processed Risks Model Documents 194, Processed Financial Product Model Documents 196, and Processed Other Documents 198 are communicated back and forth among Computer System 100 and computer systems of Segregated Account of An Insurance Carrier in Jurisdiction x 1300, and Insurance Carrier 1302; Segregated Account of Another Insurance Carrier in Jurisdiction Y 1310, and Another Insurance Carrier 1312; Beneficiary in Jurisdiction Y 1320; Insured 1330, Insured Parent 1332, and Insured Affiliate or Captive 1334; Investor 1340; Reinsurer 1344 and Reinsurer Parent 1346; Credit Support 1342; Other Vested Parties 1350; Advisors 1360-1380; Other Consultants 1382 and Regulatory Bodies 1390 and Internet Network 1392. Such computer systems can also be viewed respectively as transmitters and/or receivers of data (e.g., over a network such as the Internet) such that a cooperation of multiple parts enables computing and data intermediates, and/or collectively integrate to enable the whole of the parts to cooperate.

FIG. 1 illustrates the nature of the financial innovation that gives rise to the need for the computer system and methods. In general, there are events that usually fluctuate in timing and/or amount but are measurable by statistical or actuarial projections or probabilities. These events uncontrolled by the affected parties can produce irregular financial results. As such, the need for a financial product or instrument to accomplish certain performance or financial guarantees in order to alleviate these irregular financial results. Such affected parties could be an Insured 10 and its Beneficiary 12. Another party could be an Insurance Carrier 20 that could offer such a financial product, a Performance Indemnity Bond 50. Such a bond could, for example, cover the difference between an employer's defined benefit pension plan's forecasted obligations and the value of the assets in the pension plan; or guarantee the presence of funds for an oil company to de-commission an off-shore oil platform and wells.

The present embodiments involve computer support for implementing a financial product or instrument to accomplish certain performance or financial guarantees. There could be a third party (the insured or party guaranteed) who is obligated to perform a certain task or tasks or to meet certain requirements for a first party (the beneficiary). The third party could then contract with a second party (the insurance carrier) who will guarantee fulfillment of the specified tasks if the third party fails to perform. The financial product may take the form of a bond that will provide for the provision of funds to complete the tasks up to a specified amount limit and for a fixed term of guarantee. Accomplishing these financial guarantees can involve implementing the financial product in different jurisdictions, preferably utilizing the capital markets more effectively, and taking advantage of different risk tolerances. Thus effectively transform insurance risk into credit risk in partnership with different corporate entities, to accomplish one or more financial guarantees.

Embodiments can be used in other applications, but these examples are particularly instructive.

Insured 10, which could be an oil company, an employer or another corporation, and possibly in jurisdiction y, can contract with Insurance Carrier 20, which could be a separate cell, a segregated account, a special purpose vehicle (SPV), possibly in jurisdiction x, to guarantee its performance to Beneficiary 30 on a Security Agreement 60. Insured 10 can pay insurance premiums to Insurance Carrier 20 and Insurance Carrier 20 can pay event claims to Beneficiary 30 under an insurance policy, a Performance Indemnity Bond 50. The workings of the Performance Indemnity Bond 50 could involve an Insurance Carrier Separate Cell 20, possibly in jurisdiction x, credit enhanced by Credit Support 22, if need be, reinsuring insurance policy, event claims in exchange for reinsurance premiums, with Investor Reinsurer Separate Cell 40, possibly in jurisdiction x. Reinsurer Parent 42, possibly in jurisdiction y, can guarantee performance under the reinsurance; and also can obtain in the capital market a credit swap on any one of the Insured 10, the Insured Parent 12, and an Insured Affiliate 14.

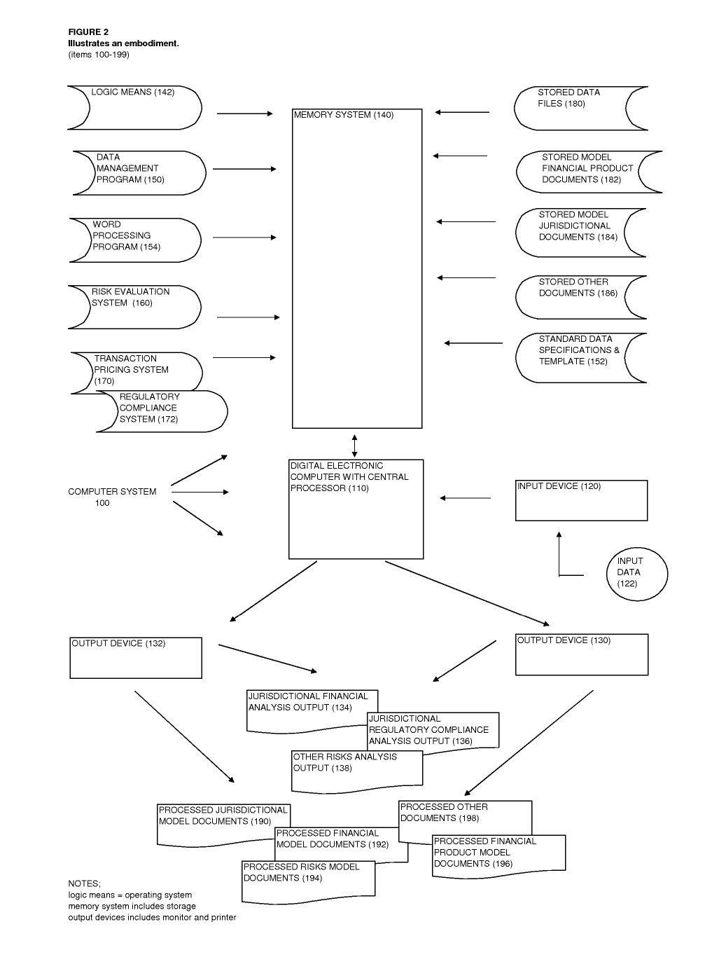

FIG. 2 provides a graphic presentation of the computer system for transforming an insurance risk into a credit risk to accomplish certain performance or financial guarantees. In this embodiment, there can be a Computer System 100 (i) that manipulates digital electrical signals comprising (a) Input Data 122 which could include parties to the transaction, specifications of financial guarantees, descriptions of risks, statistical assumptions for risks, financial assumptions for risks and other pricing data, (b) model documents including Stored Model Financial Product Documents 182, Stored Model Jurisdictional Documents 184, and Stored Other Documents 186, and (c) previously encoded and processed data Stored Data Files 180; (ii) that transforms these signals into analyses of the data and assumptions; (iii) that uses these transaction specific data and assumptions and price each transaction separately; (iv) that documents the results in Jurisdictional Financial Analysis Output 134, Jurisdictional Regulatory Compliance Analysis Output 136 and Other Risks Analysis Output 138, and (v) that illustrates selected results in Processed Jurisdictional Model Documents 190, Processed Financial Model Documents 192, Processed Risks Model Documents 194, Processed Financial Product Model Documents 196 and Processed Other Documents 198.

The Computer System 100 includes a Digital Electronic Computer with Central Processor 110, a Memory System 140, an Input Device 120, and preferably two output devices, Output Device 130 and Output Device 132. The Memory System 140 includes an operating system Logic Means 142 to run the Computer System 100 and applications software. For example, the operating system could be Microsoft XP Professional that would allow use of (a) its applications software such as Microsoft EXCEL, ACCESS, and WORD, and (b) transaction pricing systems compatible with Microsoft XP Professional such as AXIS, TAS, or PROPHET. The Memory System 140 includes (a) a Word Processing Program 154 such as Microsoft Word to generate Processed Model and Other Documents 190-198 using data, assumptions, and results, (b) a Data Management Program 150 such as Microsoft EXCEL or ACCESS to manage and evaluate data files, and (c) a Transaction Pricing System 170 such as AXIS, TAS or PROPHET that access data files and assumptions and generates pricing results that interfaces with EXCEL where a Risk Evaluation System 160 and a Regulatory Compliance System 172 can be hard coded. The Input Device 120 such as a keyboard receives Input Data 122 either manually or electronically. Output Device 130 and Output Device 132, such as a printer or a CD drive; produce such relevant documents as the Analysis Output 134-138. Jurisdictional Financial Analysis Output 134, Jurisdictional Regulatory Compliance Analysis Output 136 and Other Risks Analysis Output 138, including the input data, processed results, statistical and financial assumptions, and other relevant information as well as processing logic, is normally shared via a network of computers as indicated in FIG. 23 (Computer System 100, and computer systems, Blocks 1300-1302, 1310-1312, 1320, 1330-1334, 1340-1346, 1350, 1360, 1370, 1380-1382 and 1390-1392 of parties involved such as Insurance Carrier, Another Insurance Carrier, Beneficiary, Insured, Investor, Credit Support, Reinsurer, Other Vested Parties, Advisors, Consultants, Regulatory Bodies and Internet Network) and technical discussions occur until desired results are processed and illustrated formally in Processed Model and Other Documents 190-198.

Input data 122, usually in the form of files, can include:
List of the lives associated with the contractual exposures, if any;
Characteristics of the risks associated with these lives, at least one of, sex, age, mortality rating, morbidity rating, compensation, position, job class and years of service;
Rates of decrement (in the form of statistical assumptions such as mortality rates) associated with these lives as per contractual exposures;
Documentation relevant to financial guarantees, for example, pension plan benefit provisions, decommissioning provisions
Financial assumptions, at least one of, discount rate, expense and fee;
Updates to above;
Pricing assumptions, and any updates;
Information, and updates thereto, relative to financial risks such as
   Risk profiles, including any industry credit ratings, of Insured 10, its parent and any affiliate or captive involved in the transaction;
   Formally filed documents from inception of contractual relationship between Insured 10 and Beneficiary 30, including an application for such relationship;
   Current and historical standard financial reports of said Insured 10, its parent, and any affiliate or captive, which is a party to the transaction;
   Current and historical studies commissioned by said Insured 10, its parent, and any affiliate or captive, which is a party to the transaction
   Market history of credit swaps for Insured 10, Insured's Parent and affiliated parties
Transaction data including
   Legal name of Parties to the transaction;
   Effective date of the transaction;
   Duration of the transaction;
   Mandatory renewability options;
   Transaction fees, which could be a single fee or an annual fee; and
   Other fees, at least an early termination fee.
   Processed data includes:
Expected rates of decrement, and any updates;
Expected cash flows, and other financial results, per regular time period;
Actual cash flows, and other financial results, per regular time period;
Risks analysis;
Regulatory compliance analysis;
Financial analysis;
Stochastic modeling and resulting risk curves, and any changes thereto; and
Comparative, year-to-date and historical versions of the above data.

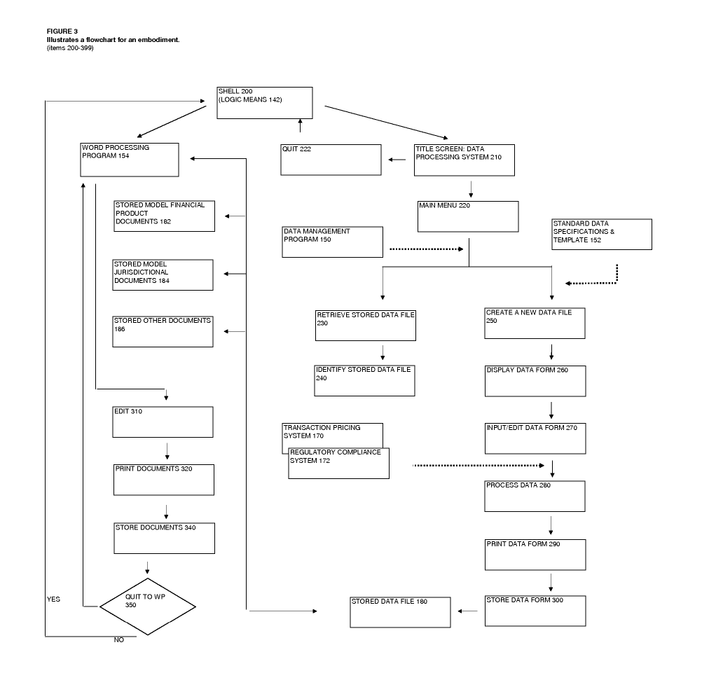

FIG. 3 is a flowchart of the overall operational processes for Computer System 100 (see FIG. 23). Shell 200 allows for two pathways, one for processing data, using Title Screen Data Processing System 210, and the other for processing model documents, using Word Processing Program 154.

Title Screen Data Processing System 210 could be a coded or programmed EXCEL application, or similar application software that allows processing of numbers and logical evaluations. Starting with Main Menu 220, that allows for the processing of information for an embodiment, and using Data Management Program 150, the system allows for creation of new data file (Block 250) and update of existing data file (Block 230, retrieval of data file and Block 240, identification of data file); then display (Block 260) and input/edit (Block 270) of data form. Using Transaction Pricing System 170 and Regulatory Compliance System 172, the system allows for the processing (Block 280) of these data files. These pricing/compliance systems generate multiple scenario results used for pricing evaluation and then the final results for the specific transaction. Using Data Management Program 150 (see FIG. 2) data information is printed (Block 290), data form (Block 300) is stored, and data file (Block 180) is stored. Using Word Processing Program 154, model and other documents are stored as per Blocks 182-186. Data files are maintained historically, per contract, from its effective date. Data storage is physically in the computer or in a computer readable file kept offsite. As defined in detail above, data includes documentation related to financial guarantees, for example, pension plan provisions, decommissioning provisions, statistical assumptions, financial assumptions, respective descriptions of risks, pricing data, information and updates relative to financial risks, expected cash flows corresponding to said risks for time periods for the duration of the contract, actual cash flows information from occurrence of events corresponding to said risks, other information relative to the guarantees in the contract.

Word Processing Program 154 allows for creating blank model documents (Blocks 182-186, financial product documents, jurisdictional documents and other documents), editing existing model documents for any updates (Block 310), printing such results (Block 320) and storing different versions of model documents (Block 340). Model documents showing current results and usually comparative, year-to-date and historical results are also produced regularly. Model documents per regular accounting periods showing actual results, expected results and risks analyses are maintained historically per contract. Computed data can be inserted into the model documents to produce custom documents as output facilitating one or more interrelationships of the embodiment.

The Logic Means 142 allows for continuing processing in Blocks 210, 220 and 350 (thru the title screen, main menu and the logic to continue with the word processing program) as well as for finalization of the process thru Blocks 222 and 350 (thru the quit routine in the title screen and the logic to quit with the word processing program).

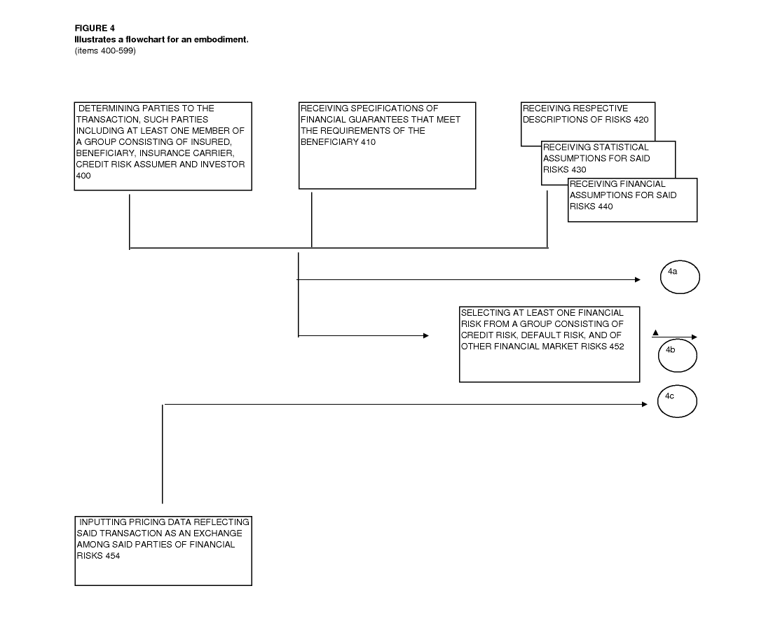

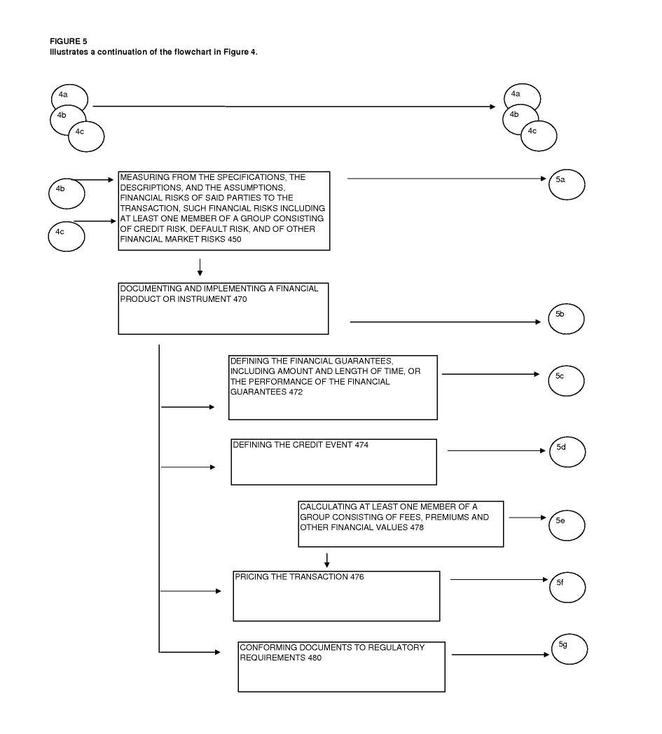

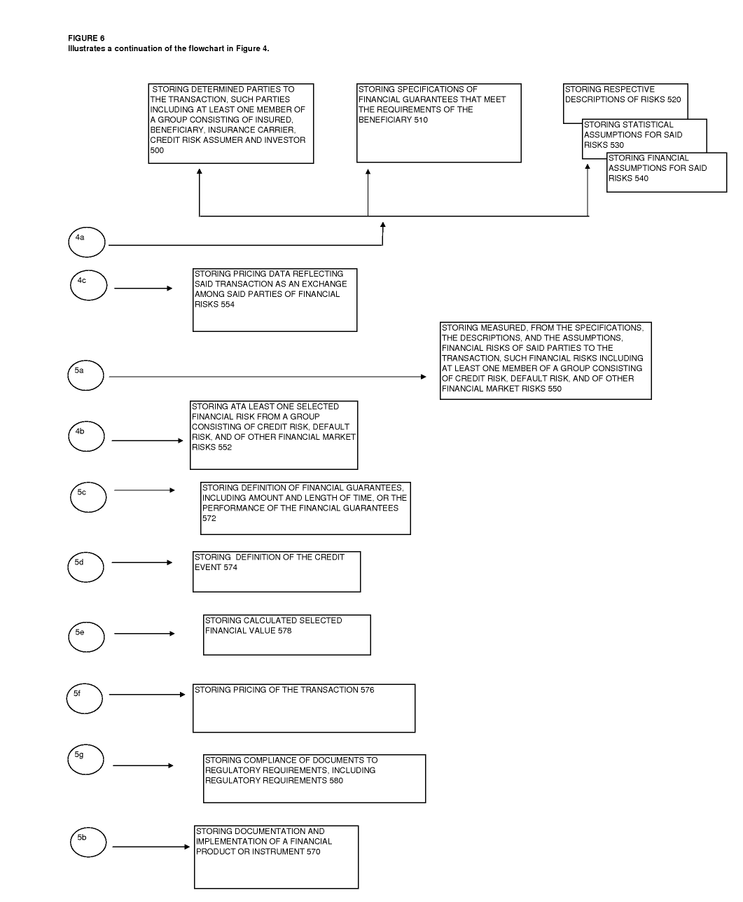

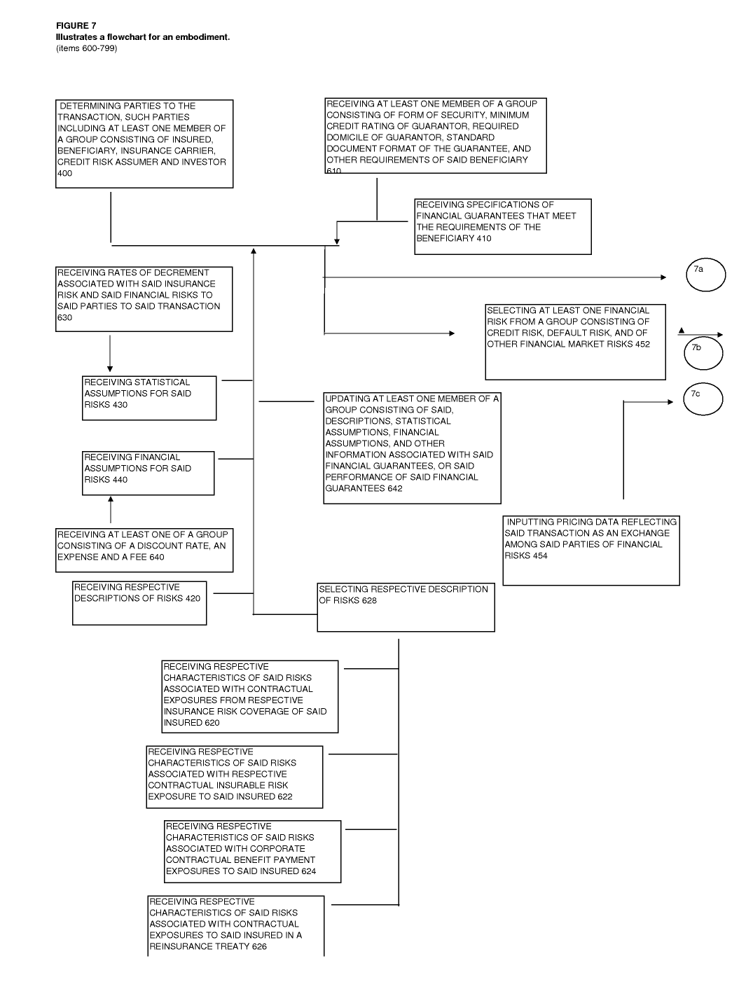

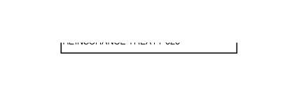

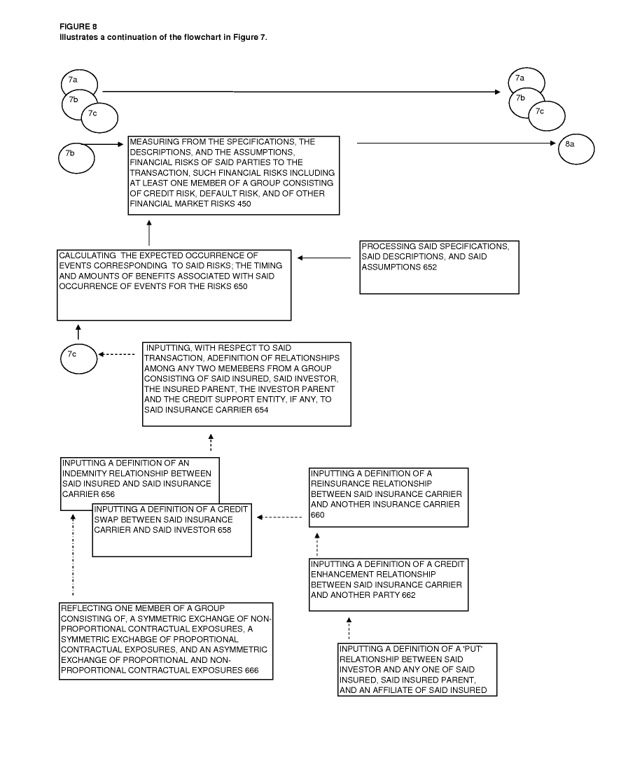

FIGS. 4-6 show the logic of the processes in a general embodiment. Input data is received starting from the early stages of preparation for the transaction and during regular time periods for the duration of the contract. The process includes Determining Parties to the Transaction, Such Parties Including at least One Member of a Group comprising (or in some embodiments, consisting of) Insured, Beneficiary, Insurance Carrier, Credit Risk Assumer and Investor 400, Receiving Specifications of Financial Guarantees that Meet the Requirements of the Beneficiary 410, Receiving Respective Descriptions of Risks 420, Receiving Statistical Assumptions for Said Risks 430, and Receiving Financial Assumptions for Said Risks 440 in order to perform Selecting at least One Financial Risk from a Group comprising (or in some embodiments, consisting of) Credit Risk, Default Risk, and Other Financial Market Risk 452; Measuring from the Specifications, the Descriptions, and the Assumptions, Financial Risks 450; and Documenting and Implementing a Financial Product or Instrument 470. The risks refer to risk parameters associated with individuals, oil and gas companies, employers, and other corporations, as is appropriate for the contractual exposures. (see FIG. 7). The statistical assumptions, such as the expected mortality rates, characterize and correspond to the risks associated with the contractual exposures. The statistical assumptions could also cover results of stochastic modeling resulting into a risk curve. The financial assumptions reflect the financial terms agreed upon by the parties to the transaction allow for measuring the financial risks for the parties, defining the credit event and the terms of a financial product, and with the pricing data allow for the pricing of the transaction including calculating fees or premiums or other financial values including reflecting any mandatory renewals. The assumptions are stored by the computer system. From time-to-time, these assumptions are reviewed and revised. Any further discussions are initiated by any of the parties for any assumption revisions that affect the terms of the transaction. The computer system maintains all relevant data for generating the financial results per regular time period, per year-to-date period, per comparative time periods and historically. Storage off-site is also maintained. Blocks 500-580 allow for the storage of information. These processes include Storing Determined Parties 500, Specifications of Financial Guarantees 510, Descriptions of Risks 520, Statistical Assumptions 530, Financial Assumptions 540, Pricing Data Reflecting Said Transaction as an Exchange of Financial Risks Among Parties 554, Measured Financial Risks 550, At Least One Selected Financial Risk 552, Definition of Financial Guarantees 572, Definition of Credit Event 574, Calculated Selected Financial Values 578, Pricing of the Transaction 576, Compliance of Documents to Regulatory Requirements and Regulatory Requirements 580, and Documentation and Implementation of a Financial Product or Instrument 570.

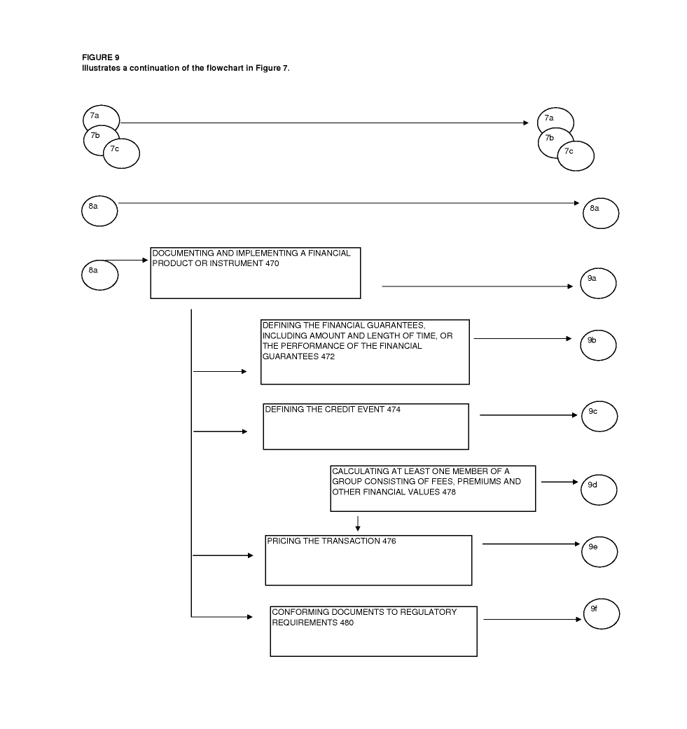

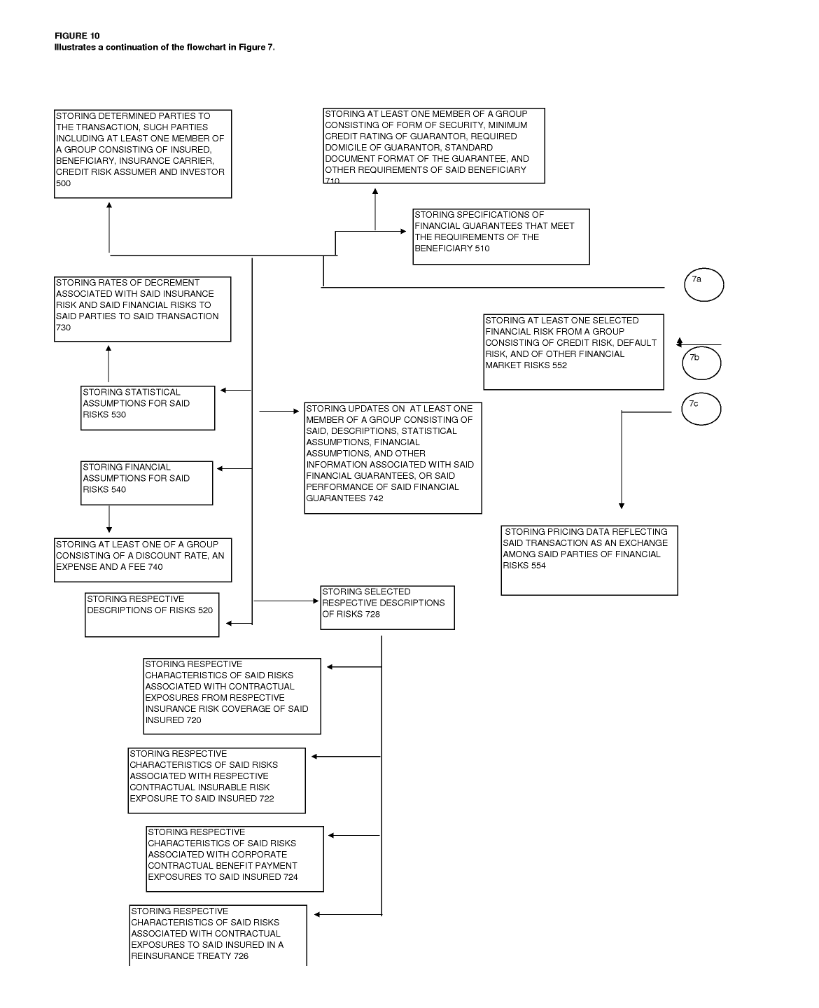

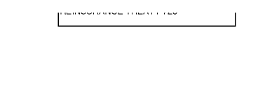

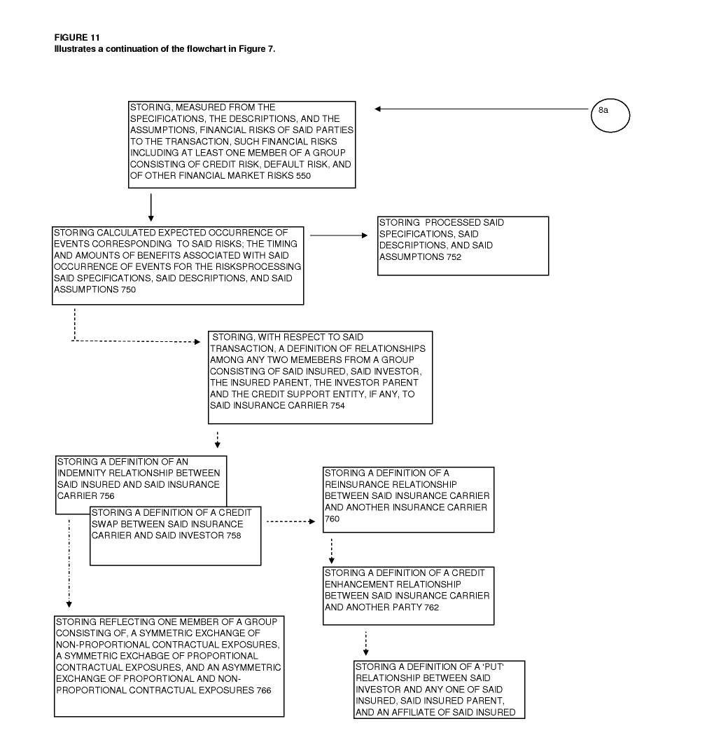

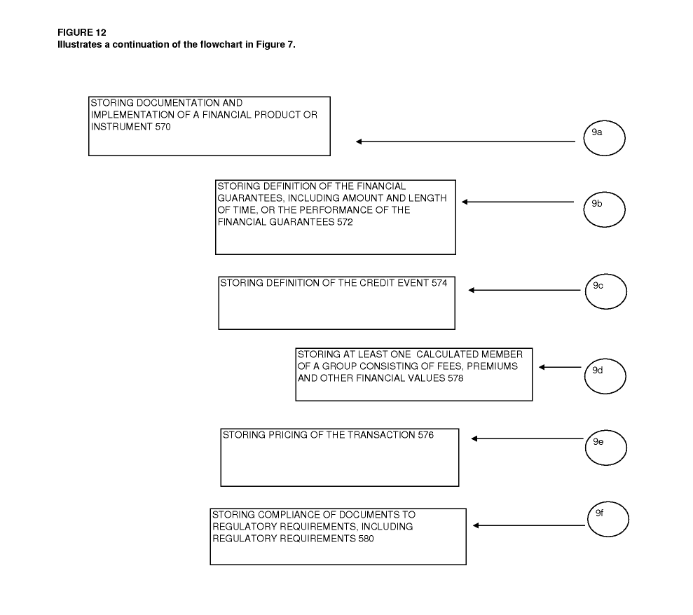

FIGS. 7-12 shows the logic of the processes in an embodiment. The embodiment involves Computer System 100 for managing performance guarantees. Of course, embodiments can be carried out with other financial guarantees, with other particular jurisdictions, and with other financial products in making use of the general idea of managing performance guarantee utilizing the capital market more effectively, and taking advantage of different risk tolerances of different corporate entities, to accomplish one or more financial guarantees. Financial guarantees can be provided but could not be accomplished as efficiently as this approach of implementing a performance indemnity bond by a full transfer of the risks to the Capital Markets, particularly the Credit Default Swap market.

Computer support will generally be useful in at least evaluating the risks and pricing the transaction at the time the contract is agreed to, as well as in tracking updates to contractual exposures as well as impact on financial risks.

Receiving respective descriptions of said risks, involves Selecting Respective Descriptions of Risks 628 (in general, characteristics associated with the actual nature of the contractual exposures from among Contractual Exposures from Respective Insurance Risk Coverage of Said Insured 620, Respective Contractual Insurable Risk Exposure to Said Insured 622, Corporate Contractual Benefit Payment Exposures to Said Insured 624 or Contractual Exposures to Said Insured in a Reinsurance Treaty 626) as is specific to the particular transaction. Additional data input includes Receiving Statistical Assumptions 430, and further Rates of Decrement Associated with Said Insurance Risk and Said Financial Risks to Said Parties to Said Transaction 630, and Financial Assumptions 440, and further At least One of a Group comprising (or in some embodiments, consisting of) a Discount Rate, an Expense and a Fee 640. Additionally are the Receiving Specifications of Financial Guarantees that Meet the Requirements of the Beneficiary 410, and Inputting Pricing Data Reflecting Said Transaction as an Exchange of Financial Risks Among Said Parties 454. All these information allows the computer to Process Specifications, Descriptions and Assumptions 652 and Calculate the Expected Occurrence of Events Corresponding to Said Risks 650. And more specifically the system Documents and Implements a Financial Product or Instrument 470. This involves Defining the Financial Guarantees 472, the Credit Event 474, Calculating Fees, or Premiums or other Financial Values 478, and thereby Pricing the Transaction 475 but ensuring Documents Conforming to Regulatory Requirements 480.

Further details can also be inputs to the transaction such as a Definition of an Indemnity Relationship between Said Insured and Said Insurance Carrier 656, whereby such relationship could reflect any of a Symmetrical Exchange of Non-Proportional Contractual Exposures, a Symmetric Exchange of Proportional Contractual Exposures or an Asymmetric Exchange of Proportional and Non-proportional Contractual Exposures 656, a Definition of a Credit Swap Between Said Insurance Carrier and Investor 658, a Definition of a Reinsurance Relationship between Said Insurance Carrier and Another Insurance Carrier 660, a Definition of a Credit Enhancement Relationship between Said Insurance Carrier and Another Party 662 and a Definition of a ‘Put’ Relationship between Said Investor and any one of Said Insured, Said Insured Parent, and Said Affiliate 664. Further details involve Defining a Relationship Among any Two Members of the Parties to the Transaction 654.

On a regular time period basis, which could be annual, quarterly and in some instance monthly, all the information gets Updating 642 and the data gets coded into the computer system.

All input data and data resulting from the logic processes are stored in the computer as indicated in Blocks 500-580, 710-776. These include storing Determined Parties 500, Specifications of Financial Guarantees 510, Details of Specifications 710, Statistical Assumptions 530, Rates of Decrement 730, Financial Assumptions 540, Details of Financial Assumptions 740, Selected Financial Risk 552, Pricing Data Reflecting Transaction as an Exchange 554, Updates 742, Descriptions of Risks 520, Details of Exposures 720-726, Selected Respective Description of Risks 728, Measured Risks 550, Processed Data 752, Calculated Expected Occurrence 750, Definitions of Relationships 750-764, Documentation and Implementation of a Financial Product or Instrument 570, Definitions of Financial Guarantees 572 and Credit Event 574, Calculated Financial Value 578, Pricing of the Transaction 576, and Compliance of the Documents to Regulatory Requirements.

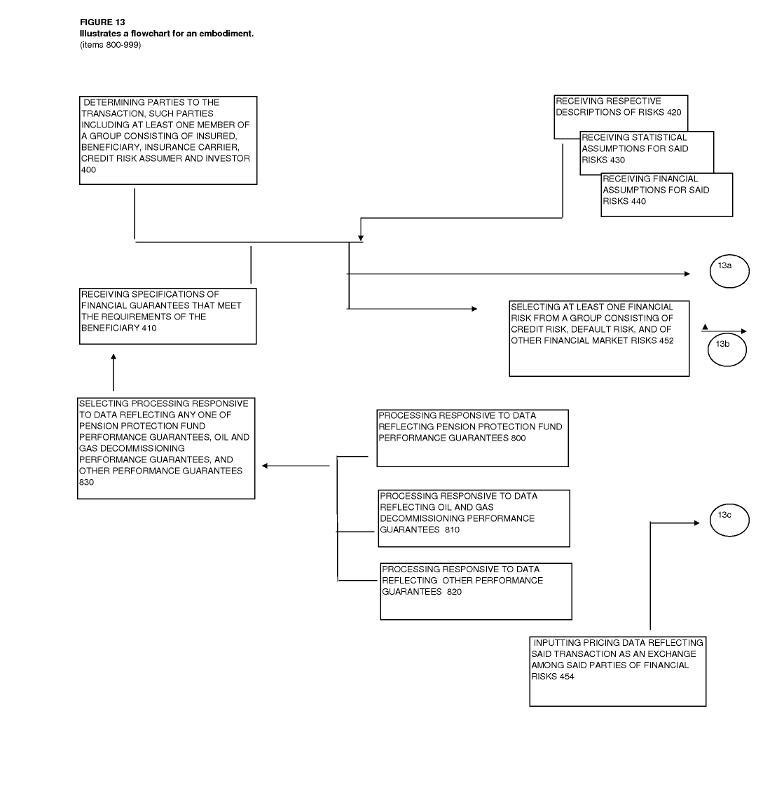

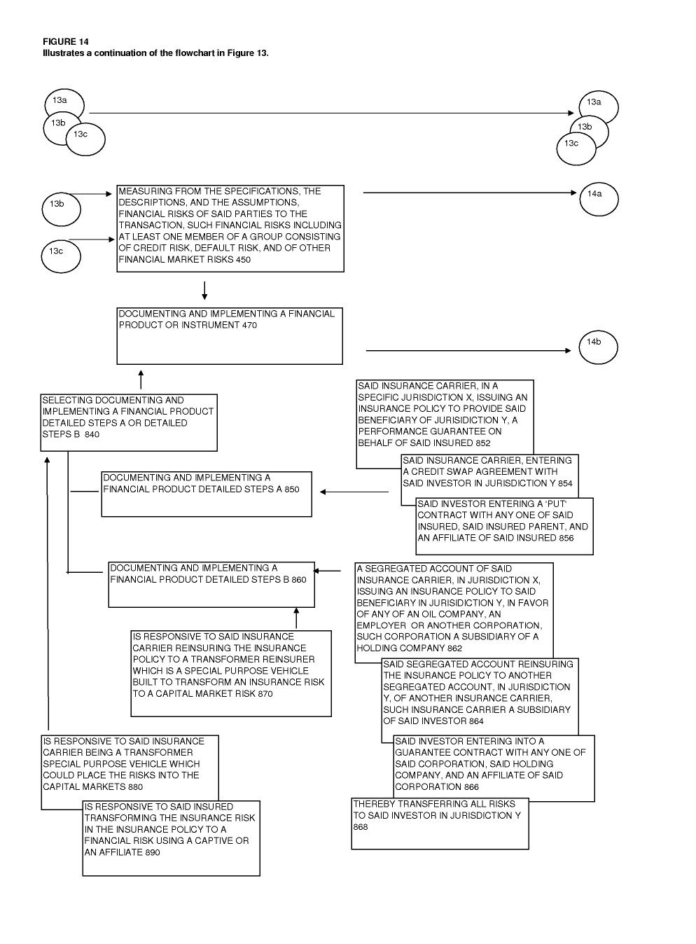

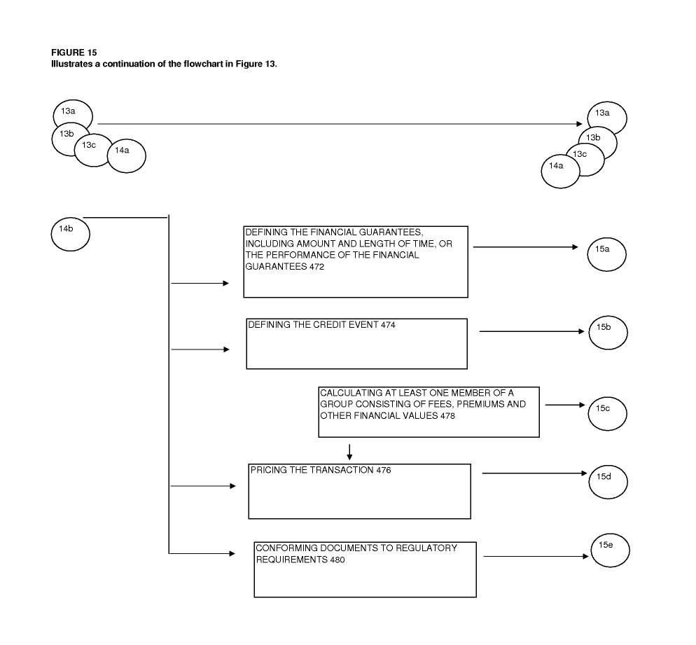

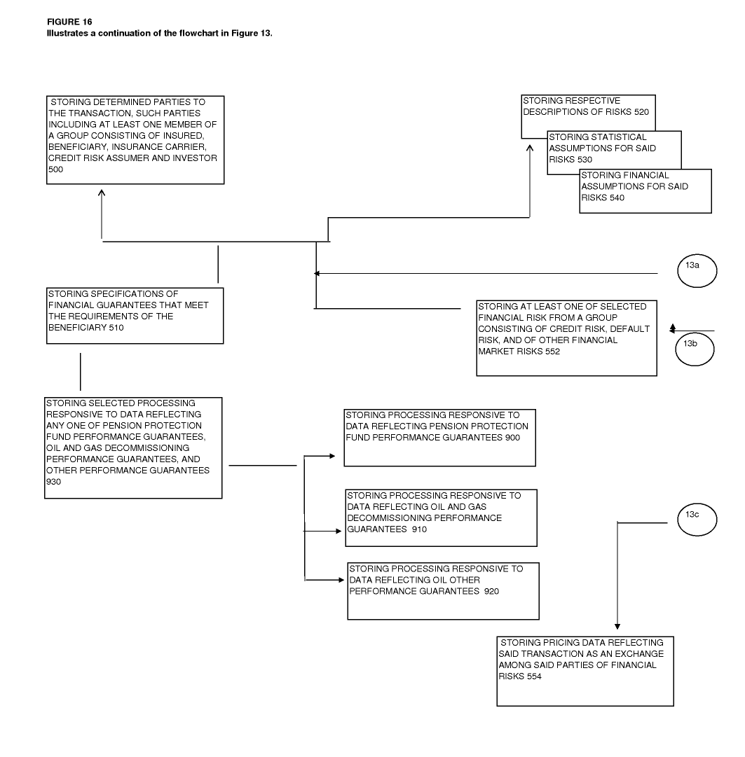

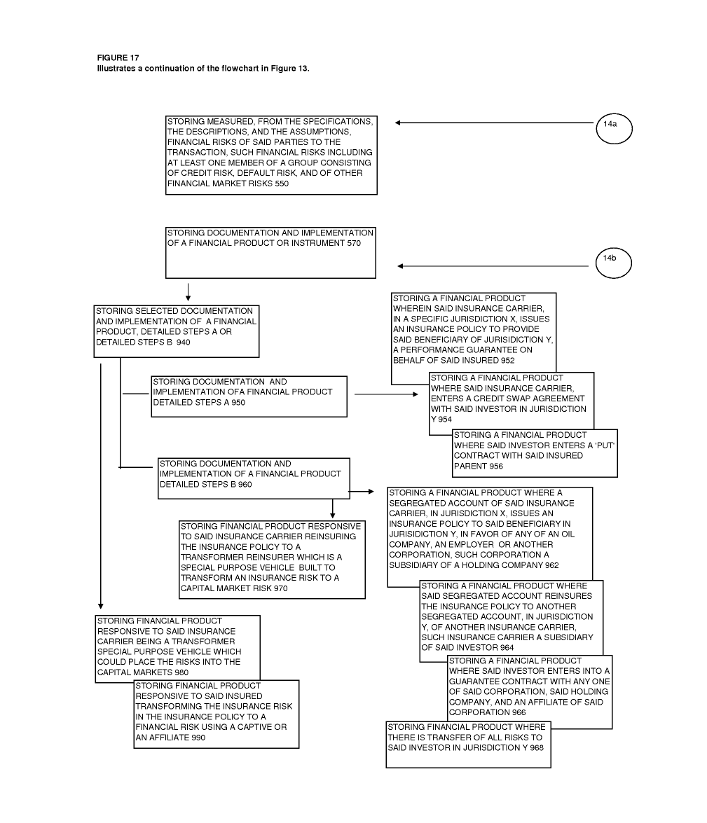

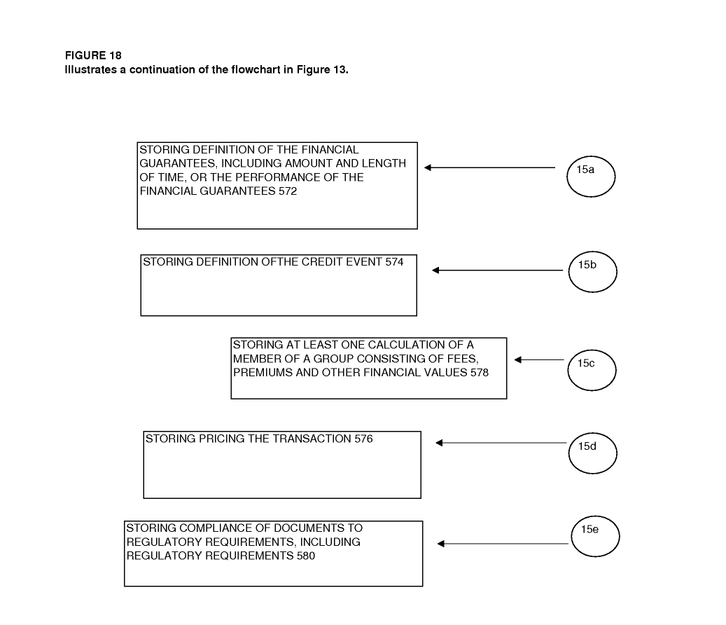

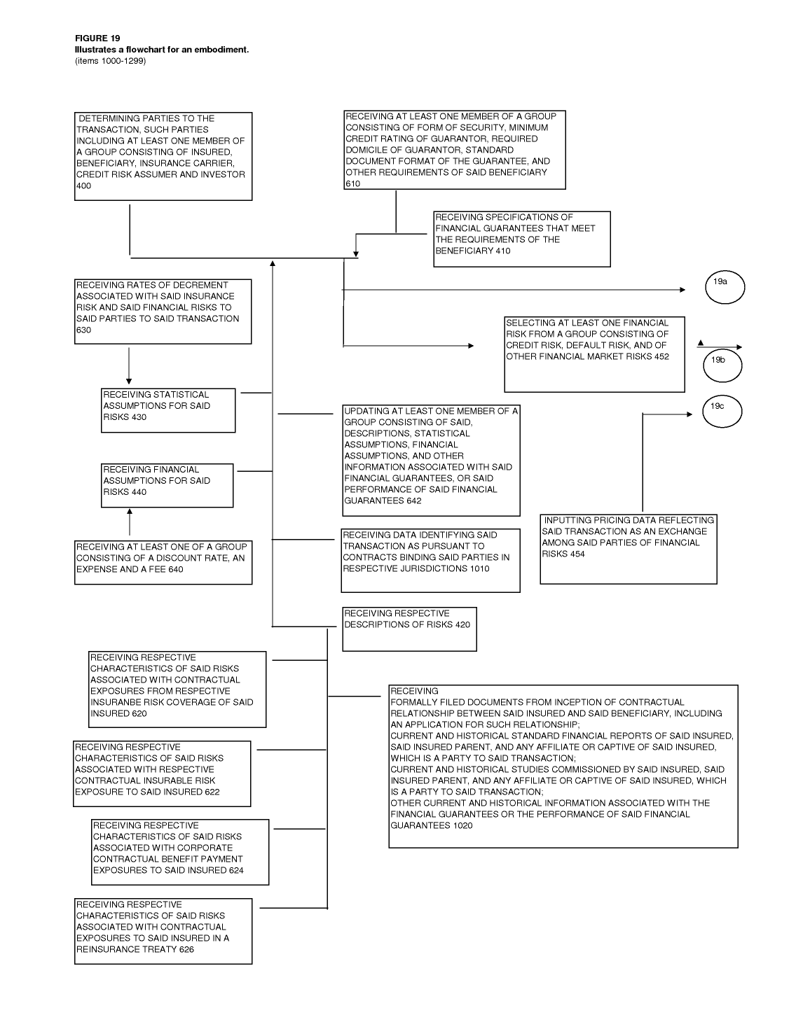

FIGS. 13-18 show the logic of the processes in an embodiment.

More particularly as a representative example, consider an Insurance Bond for a Fixed Amount and for a Fixed Term. Segregated Account A (of Insurance Carrier) in jurisdiction x, owned and guaranteed by a rated Corporation issues a Performance Indemnity Bond to the Decommissioning Authority in jurisdiction y in favor of XYZ Oil Company, a subsidiary of ABC Holdings. XYZ pays the premium. The Bond provides that, should XYZ not perform the decommissioning in jurisdiction y as specified, that Segregated Account A will pay £XXX million toward the decommissioning. The Bond is valid for 5 years, and may or may not be renewed at Segregated Account A's option.

Segregated Account A 100% co-insures the policy to Segregated Account B (of another insurance carrier) in jurisdiction x, a subsidiary of investor. Segregated Account B transfers all risk to investor in jurisdiction y. Investor is domiciled in an OECD country with a branch in jurisdiction y and with an acceptable rating in jurisdiction y. Investor enters into a contract with ABC where ABC guaranties the performance of XYZ in the decommissioning for the full term of the Bond. Investor's risk is that neither XYZ nor ABC can perform. Investor manages this risk by hedging it in the Credit Default Swap market. Investor can, for example, be required to place the contract with ABC and may be required (depending on the embodiment) to place the market hedges, in Segregated Account B.

In other embodiments, first, issuing Insurance Carrier could be a “transformer” SPV which could place the risks into the Capital Markets; second, issuing Insurance Carrier could reinsure the contract to a “transformer” reinsurer which is a SPV built to transform an insurance risk to capital market risk; or third, the transformer could be a captive or affiliate of the party whose performance is being guaranteed.

Among Blocks 800-890, all pertaining to jurisdiction, parties to the transaction and specific performance guarantees, Block 800 allows for Processing responsive to Data Reflecting Pension Protection Fund Performance Guarantees, 810 Reflecting Oil and Gas Decommissioning Performance Guarantees, 820 Reflecting other Performance Guarantees, and 830 a Selection of the above. Block 852-856 allows said Insurance Carrier, in Specific Jurisdiction x, Issuing an Insurance Policy to Provide said Beneficiary of Jurisdiction y a Performance Guarantee on Behalf of Said Insured; said Insurance Carrier entering a Credit Swap Agreement with Said Investor in Jurisdiction Y; and said Investor Entering a ‘Put’ contract with any one of Said Insured, Said Insured Parent, or an Affiliate of Said Insured; and then Documenting and Implementing said Financial Product 850. Block 862-868 allows a Segregated Account of Said Insurance Carrier in Jurisdiction x, issuing an Insurance Policy to said Beneficiary in Jurisdiction y in favor of a Corporation, a subsidiary of a Holding Company; said Segregated Account Reinsuring the Insurance Policy to another Segregated Account in Jurisdiction y of another Insurance Carrier, such Insurance Carrier a subsidiary of said Investor; said Investor Entering into a Guarantee Contract with any one of Said Corporation, said Holding Company, or an Affiliate of Said Corporation; thereby Transferring all Risks to said Investor in jurisdiction y; and then Documenting and Implementing such a Financial Product 860. Further the Financial Products, or the Selected Documentation and Implementation of a Financial Product 840, could be Responsive to said Insurance Carrier Reinsuring the Insurance Policy to a Transformer Reinsurer which is a Special Purpose Vehicle built to Transform an Insurance Risk to a Capital Market Risk 870; or Responsive to said Insurance Carrier being a Transformer Special Purpose Vehicle that could Place the Risks into the Capital Markets 880; or Responsive to said Insured Transforming the Insurance Risk in the Insurance Policy to a Financial Risk using a Captive or an Affiliate 890

Blocks 900-990 are newly processed data stored in the Computer System 100 Storage Data Files 180-186. These reflect new configurations of relationships among the parties to the transaction.

Blocks 400-480 include the processes of Receiving inputs, Determining Parties, Selecting Financial Risk, Measuring Financial Risks, Documenting and Implementing a Financial Product or Instrument, Defining Financial Guarantees, Credit Event, Calculating a Financial Value, Pricing the Transaction and Conforming Documents to Regulatory Requirements.

Blocks 500-580 are stored processed data described above.

All these detailed processes are coded into the Computer System 100.

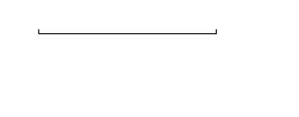

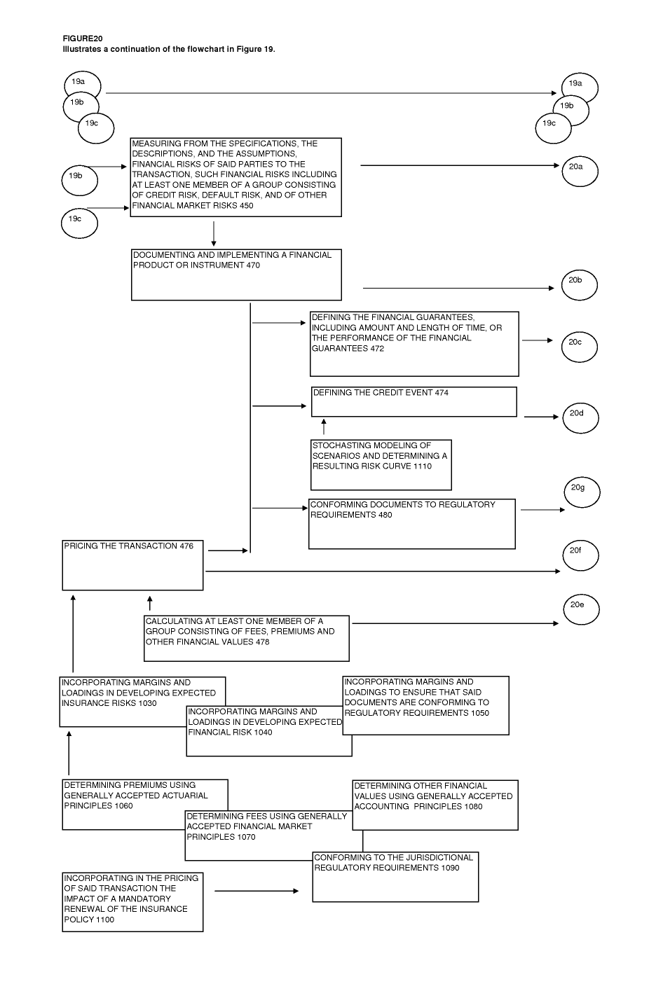

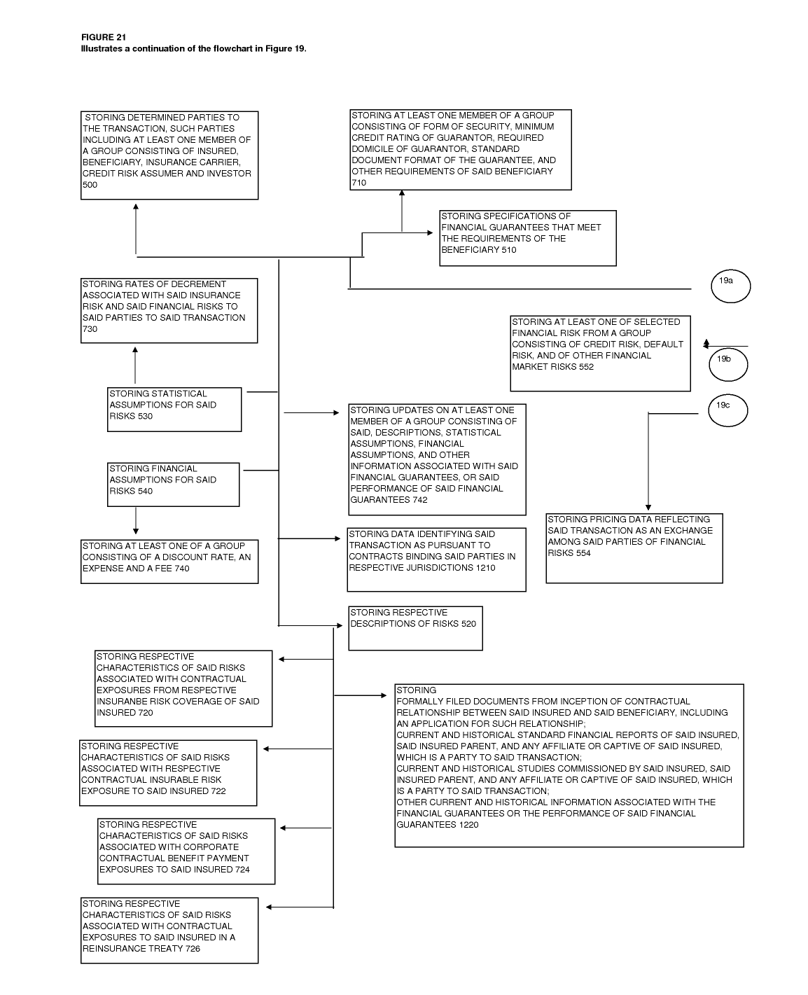

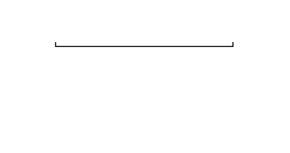

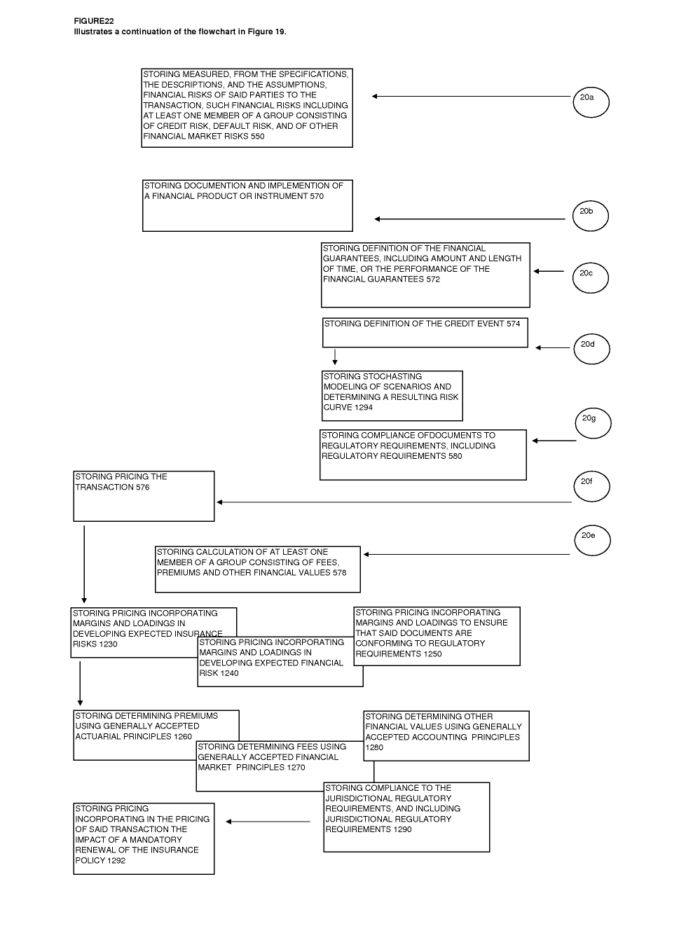

FIGS. 19-22 show the logic of the processes in an embodiment. The detailed process further includes Blocks 1010-1100 whereby Block 1010 Receives further Data Identifying Said Transaction as Pursuant to Contracts Binding said Parties in Respective Jurisdiction; Block 1020 Receives Documents relating to Relationship between said Insured and said Beneficiary, Financial Reports, Studies and other Information, Current or Historical, pertaining to said Insured, Insured Parent, or any Affiliate or Captive of the Insured which is a Party to the Transaction. Block 1030-1050 allows for Incorporating Margins and Loadings in Developing Expected Insurance Risks, Expected Financial Risks, and to ensure that Documents are Conforming to Regulatory Requirements. Blocks 1060-1080 allows Using Generally Accepted Actuarial Principles in Determining Premiums, Generally Accepted Financial Markets Principles in Determining Fees and Generally Accepted Accounting Principles in Determining other Financial Values; and that Block 1090 Conforming to the Jurisdictional Regulatory Requirements and further in Block 1100 Incorporating in the Pricing of said Transaction the Impact of Mandatory Renewal of Insurance Policy. Blocks 1220-1292 represents all the new Processed Information, Said Transaction as Pursuant to Contracts Binding said Parties, Documents, Financial Reports, Studies and Other Information, Margins and Loadings, Generally Accepted Principles for Calculating Financial Values, and Impact of Mandatory Renewal of Insurance Policy.

Blocks 400-480, 610-642, of Receiving Data, Measuring, Selecting, Documenting and Implementing, Defining, Stochastic Modeling, Calculating, and Pricing 610-642, and Storing such in Blocks 500-580, 700-742.

FIG. 23 shows the involvement of the invertors' network of computer systems as well as the computer systems of all interested and involved parties Blocks 1300-1392. These interested and involved bodies include the inventors, the parties to the transaction, consultants, regulatory bodies and other bodies that provide input data to the transaction. Information shared among these bodies includes Jurisdictional Financial Analysis Output, Jurisdictional regulatory Compliance Analysis Output and Other risks Analysis Output and Processed Model Documents.

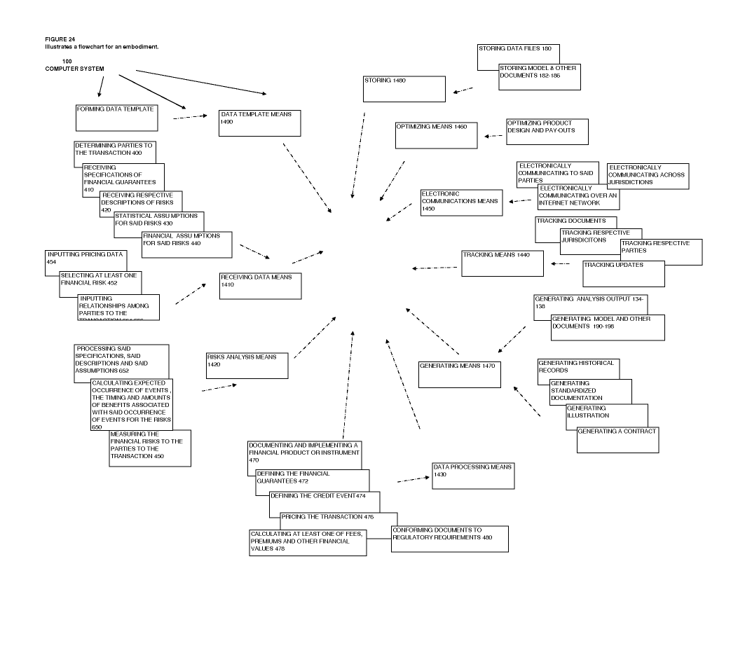

FIG. 24 shows the apparatus means that would technically allow the transformation of the insurance risk into credit risk to accomplish one or more financial guarantees. In general, the computer system includes means for determining the parties to the transaction, means for receiving specifications of financial guarantees, means for receiving respective descriptions of risks, means for receiving statistical assumptions for the risks, means for receiving financial assumptions for the risks and data processing means comprising measuring means and documenting and implementing means. In this embodiment, the Computer System 100 would at least need to have apparatus means such as Data Template Means 1490 to allow formation of data templates for data received and data produced and data shared and data used in model documents; a Receiving Data Means 1410 to allow Determination of Parties to the Transaction 400, Receiving Specifications of Financial guarantees 410, Receiving Respective Descriptions of risks 420, Statistical Assumptions 430, Financial Assumptions 440, Inputting Pricing Data 454, Selecting At Least One Financial Risk 452, and Inputting Contractual Relationships among Parties to the Transaction 654-666; and Risks Analysis Means 1420 to allow Processing Said Specifications, Said Descriptions and Said Assumptions 652 in Calculating Expected Occurrence of Events, the Timing and Amounts of Benefits Associated with such 650 and in Measuring the Financial Risks to Said Parties to the Transaction 450. Further there would be need for Data Processing Means 1430 that allows for Documenting and Implementing a financial Product or Instrument 470 which includes Defining financial Guarantees 472, Credit Event 474, Pricing 476 Calculating Financial Values 478 and of course Conforming Documents to Regulatory Requirements 480. Generating Means 1470 to generate historical records, standardized documents, illustration and contract, for example. There will also be analysis output and model and other documents output. Tracking Means 1440 will allow for tracking documents, jurisdictions, parties and updates. Electronic Communication Means 1450 to allow for communicating among parties, across jurisdictions, and over an internet network. Optimizing Means 1460 to ensure optimal design and pay-outs. Of course Storing Means 1480 for data files, and model and other documents. To name a few of the necessary means of the apparatus to technically allow the transformation of insurance risk into credit risks to accomplish one or more financial guarantees, to allow implementation in different jurisdictions, preferably utilizing the capital markets more effectively, and taking advantage of different risk tolerances in a partnership among different corporate entities.

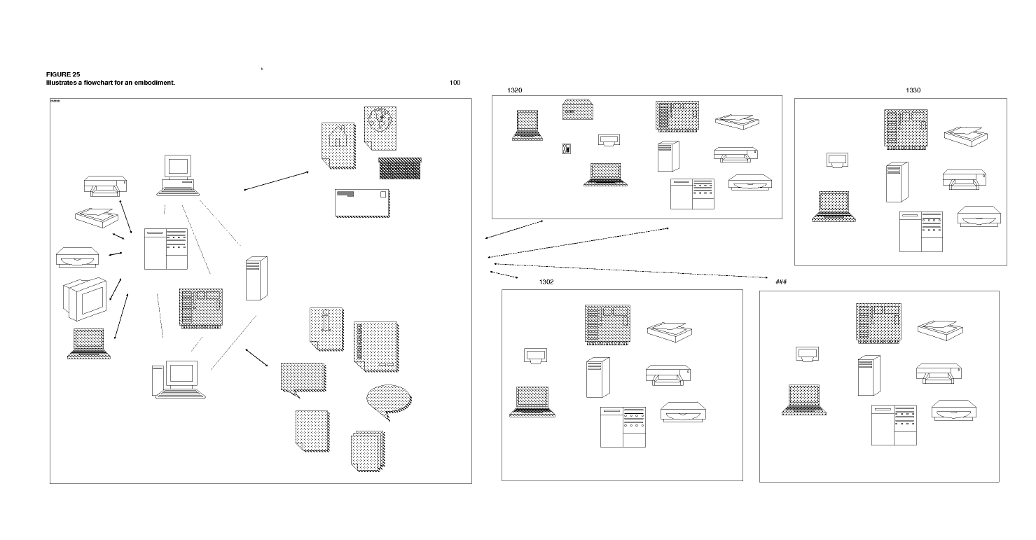

FIG. 25 shows a partial physical representation of the computer systems in the network of computer systems that would allow for the technical solution to the transformation of the insurance risk into credit risk to accomplish one or more financial guarantees. Computer system 100 has most of the apparatus means to allow such transformation. Communications are necessary at least among an Insurance Carrier System 1302, an Insured Computer system 1330, a Beneficiary Computer System 1320, and an Investor Computer System 1340. In actuality, the structure of these communicating computers systems could be more complex spanning jurisdictions, regulatory requirements, financial markets and insurance markets.

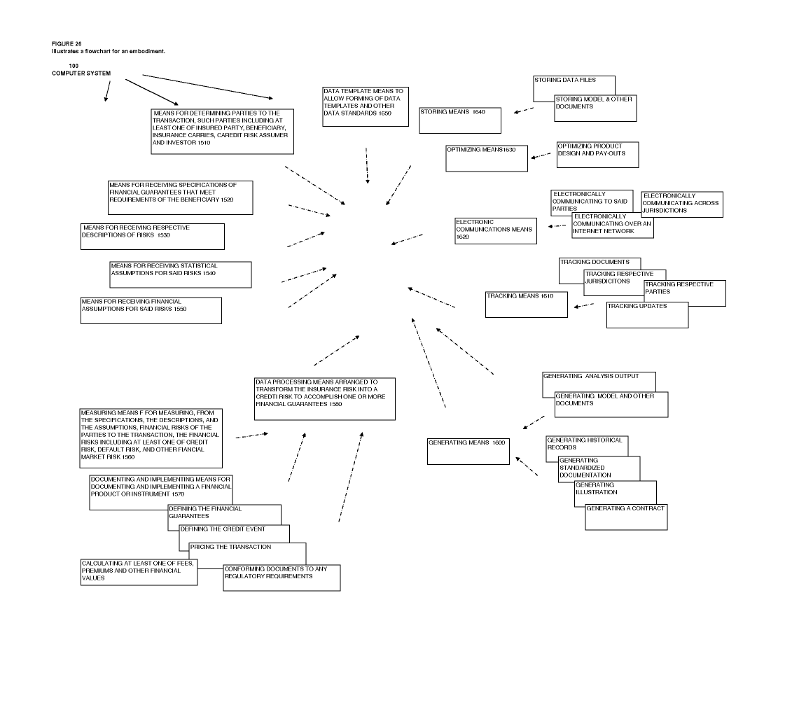

FIG. 26 shows a partial representation of the computer system in the network of computer system that allows for the technical transformation of the insurance risk into credit risk to accomplish one or more financial guarantees. Computer System 100 incorporates Means for Determining Parties to the Transaction 1510, Means for Receiving Specifications 1520, Means for Respective Descriptions 1530, Means for Receiving Statistical Assumptions 1540, Means for Receiving Financial Assumptions 1550, and Data Processing Means 1580 which includes Measuring Means 1560, documenting and Implementing Means 1570 that allows for defining financial guarantees, credit event, calculating financial values and conforming documents to any regulatory requirements. Of course, there are means for Data Template 1650, Storing 1640, Electronic Communications 1620, Optimizing 1630, Tracking 1610 and Generating 1600.

Note that in enabling cooperation between the distinct computers involved selectively, as in allowing a particular transaction in particular jurisdictions, one embodiment is directed to communicating an active code element, program, or logic means (generally referenced herein after as “an active element”) from one of the computers to another. The active element can be delivered from one of the computers to another of the computers, and once delivered, can be installed, utilized, and/or persist on the receiving one of the computer systems as well as on the sending one of the computer systems. The active element can be a stand-alone or desktop application designed and written to support the transactional operating aspects herein described. Alternatively, the active element can be designed and written as a module or extension to function within another application already present on the receiving one of the computer systems, for example a Java Applet or Active X component designed to execute in a web browser such as Firefox or Internet Explorer, or alternatively or Excel or other spreadsheet, such that the active element can be implemented by respectively involved computer systems. Given that multiple computers of the distinct entities are to cooperate, including by communicating digitally and preferably so as to include sharing of an active element, each computer in the system related to a particular transaction can be viewed as a transmitter, as a receiver, and even both, adapted to carry out cooperative functioning in accordance with the particular implementation of individual interest. So, for example, to illustrate carrying out any of the embodiments herein, consider illustratively an electronic transmission apparatus including: a computer system comprising program control means adapted to transmit a communication to another computer of another jurisdiction to enable cooperatively transforming an insurance risk into a credit risk comprising one or more financial guarantees. Conversely, consider an electronic receiver apparatus including: a computer system comprising program control means adapted to receive a communication from another computer of another jurisdiction to enable cooperatively transforming an insurance risk into a credit risk comprising one or more financial guarantees. With regard to the transmission or receiver apparatus, the communication can comprise an active element, as discussed above. Preferably the transmission an receiver apparatus are comprised in a system having central control means adapted to facilitate the transforming.

With this in mind, embodiments herein extend to computer-readable media tangibly embodying a program of instructions executable by a computer to perform the operations to carry out at least a portion of the embodiments herein, e.g., some or all transactional computing at least one of the involved computers. Illustratively, then, the operations can facilitate centrally enabling transformation of an insurance risk for a transaction, in cooperation with computers of different entities, in facilitating: determining parties to a transaction, the parties including a plurality of the group including an insured, beneficiary, insurance carrier, credit risk assumer, and investor; receiving specifications of financial guarantees that meet requirements of the beneficiary; receiving respective descriptions of risks; receiving statistical assumptions for said risks; receiving financial assumptions for said risks; measuring, from the specifications, the descriptions, and the assumptions, financial risks of said parties to the transaction, the financial risks including at least one member of a group including credit risk, default risk, and of other financial market risks; and documenting and implementing a financial product or instrument, including: defining financial guarantees, including amount and length of time, or performance of the financial guarantees; defining a credit event; pricing the transaction, including calculating at least one member of a group including fees, premiums, and other financial value; and conforming documents to regulatory requirements, if any; to transform an insurance risk into a credit risk comprising one or more financial guarantees. As indicated above, the media can comprise at least one of a RAM, a ROM, a disk, an ASIC, and a PROM.

In sum, computer machine, manufacture, methods of making and using the same, and product produced thereby, as well as necessary intermediates, each pertaining to a system of the kind useful in managing performance guarantees.

A method implemented with a machine, the machine, and the method for using the machine, and products produced thereby, the method including a digital electronic computer having a processor programmed for electronically processing input data into output data, the computer electronically connected to an input device and to output devices, for transforming insurance risks related to specific contractual exposures as embodied in the insurance policy (either underlying indemnity, reinsurance, benefit payment, other contractual exposures of insured), measuring financial risks to parties to the transaction, maintaining and storing such calculations, periodically comparing the expected and projected results to actual occurrences results as inputted into the computer, updating risk profiles, continually monitoring differences between actual and projected results and preparing reports of the results of the calculations. The method includes entering into the computer the assumptions specific to the contractual exposures for the transaction, the data respecting the covered risks, and the pricing data reflecting risks and costs; entering the specific relationships among parties to the transaction, among the insurance policy, the credit swaps, the performance guarantees, and the financial guarantees required of the insured by the beneficiary; engaging the computer to determine, select, measure, document and implement the financial product, thereby defining amount and length of time of financial guarantee or the performance thereof, defining the credit event for which there could be an event claim and payment, calculating fees, or premiums or other financial values in the pricing and conforming the document to regulatory requirements; monitoring new information, new reports, and other new developments relevant to the contractual exposures of/to the insured regarding the financial guarantees or performance thereof and inputting such information into the computer to update risks and risks profiles for the duration of the transaction. The method reflecting transforming insurance risks into credit risks to accomplish one or more financial guarantees and reflecting processes in multiple jurisdictions.

Appreciation is requested for the robust range of possibilities flowing from the core teaching herein. More broadly, however, the terms and expressions which have been employed herein are used as terms of teaching and not of limitation, and there is no intention, in the use of such terms and expressions, of excluding equivalents of the features shown and described, or portions thereof, it being recognized that various modifications are possible within the scope of the embodiments contemplated and suggested herein. Further, various embodiments are as described and suggested herein. Although the disclosure herein has been described with reference to specific embodiments, the disclosures are intended to be illustrative and are not intended to be limiting. Various modifications and applications may occur to those skilled in the art without departing from the true spirit and scope defined in the appended claims.

Thus, although only a few exemplary embodiments have been described in detail above, those skilled in the art will readily appreciate that many modifications are possible in the exemplary embodiments without materially departing from the novel teachings and advantages herein. Accordingly, all such modifications are intended to be included within the scope defined by claims. In the claims, means-plus-function claims are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment fastening wooden parts, a nail and a screw may be equivalent structures.

We claim:

1. A computer system programmed to transform insurance risk for a transaction, in partnership with different corporate entities, the computer system comprising:
means for determining parties to the transaction, such parties including at least one of insured party, beneficiary, insurance carrier, credit risk assumer and investor;
means for receiving specifications of financial guarantees that meet requirements of the beneficiary;
means for receiving respective descriptions of risks;
means for receiving statistical assumptions for the risks;
means for receiving financial assumptions for the risks; and
data processing means arranged to transform the insurance risk into a credit risk to accomplish one or more financial guarantees, the data processing means comprising:
measuring means for measuring, from the specifications, the descriptions, and the assumptions, financial risks of the parties to the transaction, the financial risks including at least one of credit risk, default risk, and other financial market risks;
documenting and implementing means for documenting and implementing a financial product or instrument, the documenting and implementing means being arranged to: define the financial guarantees, including amount and length of time, or the performance of the financial guarantees; define the credit event; price the transaction, including calculate at least one of fees, premiums, and other financial values; and conform documents to any regulatory requirements.

2. The computer system of claim 1, wherein the means for receiving specifications of financial guarantees is arranged to receive at least one member of a group of:
form of security, minimum credit rating of guarantor, required domicile of guarantor, standard document format of the guarantee, and other requirements of said beneficiary.

3. The computer system of claim 1, wherein the means for receiving respective descriptions of risks is arranged to receive respective characteristics of said risks associated with contractual exposures from respective insurable risk coverage of said insured.

4. The computer system of claim 1, wherein the means for receiving respective descriptions of risks is arranged to receive respective characteristics of said risks associated with respective contractual insurable risk exposure to said insured.

5. The computer system of claim 1, wherein the means for receiving respective descriptions of risks is arranged to receive respective characteristics of said risks associated with corporate contractual benefit payment exposures to said insured.

6. The computer system of claim 1, wherein the means for receiving respective descriptions of risks is arranged to receive respective characteristics of said risks associated with contractual exposures to said insured in a reinsurance treaty.

7. The computer system of claim 1, wherein the means for measuring, from the specifications, the descriptions and the assumptions, financial risks of said parties to the transaction, includes means for processing said specifications, said descriptions, and said assumptions, means for calculating the expected occurrence of events corresponding to said risks, including calculating the timing and amounts of benefits associated with said occurrence of events for the risks; and wherein said calculating timing and amounts of benefits includes means for inputting pricing data reflecting said transaction as an exchange among said parties of financial risks including at least one member of a group of credit risk, default risk, and of other financial market risk.

8. The computer system of claim 7 wherein the means for inputting pricing data includes:
means for inputting, with respect to said transaction, a definition of relationships among any two members from a group of said insured, said investor, the insured parent, the investor parent and the credit support entity, if any, to said insurance carrier.

9. The computer system of claim 8, wherein the means for inputting pricing data includes:
means for inputting a definition of an indemnity relationship between said insured and said insurance carrier; and
means for inputting a definition of a credit swap relationship between said insurance carrier and said investor.

10. The computer system of claim 9, wherein the means for inputting pricing data further includes:
means for inputting a definition of a reinsurance relationship between said insurance carrier and another insurance carrier.

11. The computer system of claim 10, wherein the means for inputting pricing data further includes:
means for inputting a definition of a credit enhancement relationship between said insurance carrier and another party.

12. The computer system of claim 11 wherein the means for inputting pricing data further includes:
means for inputting a definition of a ‘put’ relationship between said investor and any one of insured, insured parent and an affiliate of the insured.

13. The computer system of claim 9, further including means for reflecting one member of a group of, a symmetric exchange of non-proportional contractual exposures, a symmetric exchange of proportional contractual exposures, and an asymmetric exchange of proportional and non-proportional contractual exposures.

14. The computer system of claim 1, further including means for processing responsive to data reflecting pension protection fund performance guarantees.

15. The computer system of claim 1 further including means for processing responsive to data reflecting oil and gas decommissioning performance guarantees.

16. The computer system of any one of claims 2-6, wherein the means for receiving respective descriptions of risks is arranged to receive:
formally filed documents from inception of contractual relationship between said insured and said beneficiary, including an application for such relationship;
current and historical standard financial reports of said insured, said insured parent, and any affiliate or captive of said insured, which is a party to said transaction;
current and historical studies commissioned by said insured, said insured parent, and any affiliate or captive of said insured, which is a party to said transaction;
other current and historical information associated with the financial guarantees or the performance of said financial guarantees.

17. The computer system of claim 1, wherein the pricing the transaction, including calculating at least one member of a group of fees, premiums, and other financial values, further includes:
incorporating margins and loadings in developing expected insurance risks;
incorporating margins and loadings in developing expected financial risks; and
incorporating margins and loadings to ensure that said documents are conforming to regulatory requirements.

18. The computer system of claim 17, wherein the pricing the transaction further includes:
determining premiums using generally accepted actuarial principles;
determining fees using generally accepted financial market principles; and
determining other financial values using generally accepted accounting principles, conforming to the jurisdictional regulatory requirements.

19. The computer system of claim 1 wherein the defining said credit event includes stochastic modeling of scenarios and determining a resulting risk curve.

20. The computer system of any of claims 3-6, wherein the means for receiving statistical assumptions is arranged to receive rates of decrement associated with said insurance risk and said financial risks to said parties to said transaction.

21. The computer system of claim 20, wherein the means for receiving financial assumptions is arranged to receive at least one of a group of a discount rate, an expense, and a fee.

22. The computer system of claim 21, further arranged to update at least one member of a group of said, descriptions, statistical assumptions, financial assumptions, and other information associated with said financial guarantees, or said performance of said financial guarantees.

23. The computer system of claim 18, further arranged to incorporate in the pricing of said transaction the impact of a mandatory renewal of the insurance policy.

24. The computer system of claim 1, further arranged to receive data identifying said transaction as pursuant to contracts binding said parties in respective jurisdictions.

25. A computer-aided method of transforming insurance risk for a transaction, in cooperation with different entities, the method including:
determining parties to a transaction, the parties including a plurality of the group including an insured, beneficiary, insurance carrier, credit risk assumer, and investor;
receiving specifications of financial guarantees that meet requirements of the beneficiary;
receiving respective descriptions of risks;
receiving statistical assumptions for said risks;
receiving financial assumptions for said risks;
measuring, from the specifications, the descriptions, and the assumptions, financial risks of said parties to the transaction, the financial risks including at least one member of a group including credit risk, default risk, and of other financial market risks; and
documenting and implementing a financial product or instrument, including:
defining financial guarantees, including amount and length of time, or performance of the financial guarantees;
defining a credit event;
pricing the transaction, including calculating at least one member of a group including fees, premiums, and other financial value; and
conforming documents to regulatory requirements, if any;
to transform an insurance risk into a credit risk comprising one or more financial guarantees.

26. The method of claim 25, wherein the receiving specifications of financial guarantees includes receiving at least one member of a group comprising a security, a minimum credit rating of guarantor, a required domicile of guarantor, a standard document format of the guarantee, and an other requirement of said beneficiary.

27. The method of claim 25, wherein the receiving respective descriptions of risks includes receiving respective characteristics of said risks associated with contractual exposures from respective insurable risk coverage of said insured.

28. The method of claim 25, wherein the receiving respective descriptions of risks includes receiving respective characteristics of said risks associated with respective contractual insurable risk exposure to said insured.

29. The method of claim 25, wherein the receiving respective descriptions of risks includes receiving respective characteristics of said risks associated with corporate contractual benefit payment exposures to said insured.

30. The method of claim 25, wherein the receiving respective descriptions of risks includes receiving respective characteristics of said risks associated with contractual exposures to said insured in a reinsurance treaty.

31. The method of claim 25, wherein the measuring, from the specifications, the descriptions, and the assumptions, financial risks of said parties to the transaction, includes the processing said specifications, said descriptions, and said assumptions, in calculating an expected occurrence of events corresponding to said risks; timing and amounts of benefits associated with said occurrence of the events for the risks; and wherein said calculating timing and amounts of benefits includes inputting pricing data reflecting said transaction as an exchange among said parties of financial risks including at least one member of a group including credit risk, default risk, and an other financial market risk.

32. The method of claim 31 wherein the inputting pricing data includes the:
inputting, with respect to said transaction, a definition of relationships among any two members from a group comprising said insured, said investor, an insured parent, an investor parent and a credit support entity, if any, to said insurance carrier.

33. The method of claim 32, wherein the inputting pricing data includes:
inputting a definition of an indemnity relationship between said insured and said insurance carrier; and
inputting a definition of a credit swap relationship between said insurance carrier and said investor.

34. The method of claim 33, wherein the inputting pricing data further includes the:
inputting a definition of a reinsurance relationship between said insurance carrier and another insurance carrier.

35. The method of claim 34, wherein the inputting pricing data further includes the:
inputting a definition of a credit enhancement relationship between said insurance carrier and another party.

36. The method of claim 35 wherein the inputting pricing data further includes:
inputting a definition of a ‘put’ relationship between said investor and any one of insured, insured parent and an affiliate of the insured.

37. The method of claim 33, further including the reflecting one member of a group comprising a symmetric exchange of non-proportional contractual exposures, a symmetric exchange of proportional contractual exposures, and an asymmetric exchange of proportional and non-proportional contractual exposures.

38. The method of claim 25, further including processing responsive to data reflecting pension protection fund performance guarantees.

39. The method of 25 further including processing responsive to data reflecting oil and gas decommissioning performance guarantees.

40. The method of claim 25, wherein the documenting and implementing a financial product includes:
said insurance carrier, in a specific jurisdiction x, issuing an insurance policy to provide said beneficiary, of jurisdiction y, a performance guarantee on behalf of said insured;
said insurance carrier, entering a credit swap agreement with said investor in jurisdiction y; and
said investor entering a ‘put’ contract with any one of said insured, said insured parent, and an affiliate of said insured.

41. The method of claim 25, wherein the documenting and implementing a financial product includes:
a segregated account of said insurance carrier, in jurisdiction x, issuing an insurance policy to said beneficiary in jurisdiction y in favor of any of an oil company, an employer or another corporation, such corporation a subsidiary of a holding company;
said segregated account reinsuring the insurance policy to another segregated account, in jurisdiction y, of another insurance carrier, such insurance carrier a subsidiary of said investor; and
said investor entering into a guarantee contract with any of said corporation, said holding company, and an affiliate of said corporation;
thereby transferring all risks to said investor in jurisdiction y.

42. The method of any of claims 40-41, wherein the implementing a financial product is responsive to said insurance carrier being a transformer special purpose vehicle capable of placing the risks into a capital market.

43. The method of claim 41, wherein the implementing a financial product includes implementing responsive to said insurance carrier reinsuring the insurance policy to a transformer reinsurer to bring about a special purpose vehicle built to transform an insurance risk to a capital market risk.

44. The method of any of claims 40-41, wherein the implementing a financial product is responsive to said insured transforming the insurance risk in the insurance policy to a financial risk using a captive or an affiliate.

45. The method of any one of claims 25-30, wherein the receiving respective descriptions of risks includes receiving:
formally filed documents from inception of contractual relationship between said insured and said beneficiary, including an application for such relationship;
current and historical standard financial reports of said insured, said insured parent, and any affiliate or captive of said insured, which is a party to said transaction;
current and historical studies commissioned by said insured, said insured parent, and any affiliate or captive of said insured, which is a party to said transaction;
other current and historical information associated with the financial guarantees or the performance of said financial guarantees.

46. The method of claim 25, wherein the pricing the transaction, including calculating at least one member of a group comprising fees, premiums, and other financial values, further includes:
incorporating margins and loadings in developing expected insurance risks;
incorporating margins and loadings in developing expected financial risks; and
incorporating margins and loadings to ensure that said documents are conforming to regulatory requirements.

47. The method of claim 46, further including:
determining premiums using generally accepted actuarial principles;
determining fees using generally accepted financial market principles; and
determining other financial values using generally accepted accounting principles,
conforming to jurisdictional regulatory requirements.

48. The method of claim 25 wherein the defining said credit event includes stochastic modeling of scenarios and determining a resulting risk curve.

49. The method of any of claims 27-30, wherein the receiving statistical assumptions includes receiving rates of decrement associated with said insurance risk and said financial risks to said parties to said transaction.

50. The method of claim 49, wherein the receiving financial assumptions includes receiving at least one of a group of a discount rate, an expense, and a fee.

51. The method of claim 50, further including updating at least one member of a group comprising said descriptions, said statistical assumptions, said financial assumptions, and said other information associated with said financial guarantees or associated with said performance of said financial guarantees.

52. The method of claim 47, further including:
incorporating in the pricing of said transaction the impact of a mandatory renewal of the insurance policy.

53. The method of claims 25, further including the receiving data identifying said transaction as pursuant to contracts binding said parties in respective jurisdictions.

54. A computer-readable media tangibly embodying a program of instructions executable by a computer to perform the operations of:
centrally enabling transformation of an insurance risk for a transaction, in cooperation with computers of different entities, in facilitating:
determining parties to a transaction, the parties including a plurality of the group including an insured, beneficiary, insurance carrier, credit risk assumer, and investor;
receiving specifications of financial guarantees that meet requirements of the beneficiary;
receiving respective descriptions of risks;
receiving statistical assumptions for said risks;
receiving financial assumptions for said risks;
measuring, from the specifications, the descriptions, and the assumptions, financial risks of said parties to the transaction, the financial risks including at least one member of a group including credit risk, default risk, and of other financial market risks; and
documenting and implementing a financial product or instrument, including:
defining financial guarantees, including amount and length of time, or performance of the financial guarantees;
defining a credit event;
pricing the transaction, including calculating at least one member of a group including fees, premiums, and other financial value; and
conforming documents to regulatory requirements, if any;
to transform an insurance risk into a credit risk comprising one or more financial guarantees.

55. The media of any one of claims 54, wherein the media comprises at least one of a RAM, a ROM, a disk, an ASIC, and a PROM.

56. An electronic transmission apparatus including:
a computer system comprising program control means adapted to transmit a communication to another computer of another jurisdiction to enable cooperatively transforming an insurance risk into a credit risk comprising one or more financial guarantees.

57. An electronic receiver apparatus including:
a computer system comprising program control means adapted to receive a communication from another computer of another jurisdiction to enable cooperatively transforming an insurance risk into a credit risk comprising one or more financial guarantees.

58. The apparatus of any one of claims 56-57, wherein the communication comprises an active element.

59. The apparatus of claim 58, wherein the computers comprise a system having central control of the transforming.
